(19) United States
(12) Patent Application Publication
(10) Pub. No.: US 2026/0006314 A1
(43) Pub. Date: Jan. 1, 2026

(54) ELECTRONIC DEVICE AND IMAGE CAPTURING METHOD THEREOF

(71) Applicant: Samsung Electronics Co., Ltd., Suwon-si (KR)

(72) Inventors: Hyunjun MIN, Suwon-si (KR); Yunji NOH, Suwon-si (KR); Yejin MOON, Suwon-si (KR); Jaehyun AN, Suwon-si (KR); Dongoh LEE, Suwon-si (KR); Seohoe CHUNG, Suwon-si (KR); Yeonhwa JOO, Suwon-si (KR)

(21) Appl. No.: 19/233,790

(22) Filed: Jun. 10, 2025

Related U.S. Application Data
(63) Continuation of application No. PCT/KR2025/095360, filed on May 23, 2025.

(30) Foreign Application Priority Data
Jul. 1, 2024 (KR) 10-2024-0086453
Aug. 21, 2024 (KR) 10-2024-0112289

(51) Int. Cl. H04N 23/63; H04N 23/69; H04N 23/695

(52) U.S. Cl. CPC H04N 23/635; H04N 23/69; H04N 23/695

(57) ABSTRACT

An electronic device is provided. The electronic device includes a display, a first camera having a first field of view, a second camera having a second field of view different from the first field of view, memory storing one or more computer programs, and one or more processors communicatively coupled to the display, the first camera, the second camera and the memory, wherein the one or more computer programs include computer-executable instructions that, when executed by the one or more processors individually or collectively, cause the electronic device to display, on the display, a first preview image including a first image having a first zoom magnification and acquired using the first camera, generate a first object image by extracting a first object included in the first image in response to a first user input while the first preview image is displayed, display, on the display, a second preview image obtained by overlaying the first object image on a second image having the first zoom magnification and acquired using the second camera, change the zoom magnification of the second image to a second zoom magnification, and display, on the display, a third preview image obtained by overlaying the first object image on the second image having the second zoom magnification, and store a composite image corresponding to the displayed third preview image.

### CROSS-REFERENCE TO RELATED APPLICATION(S)

This application is a continuation application, claiming priority under 35 U.S.C. § 365(c), of an International application No. PCT/KR2025/095360, filed on May 23, 2025, which is based on and claims the benefit of a Korean patent application number 10-2024-0086453, filed on Jul. 1, 2024, in the Korean Intellectual Property Office, and of a Korean patent application number 10-2024-0112289, filed on Aug. 21, 2024, in the Korean Intellectual Property Office, the disclosure of each of which is incorporated by reference herein in its entirety.

### TECHNICAL FIELD

The disclosure relates to an electronic device and a method for capturing an image by an electronic device.

### BACKGROUND ART

A portable electronic device (hereinafter, referred to as an electronic device) such as a smartphone or a tablet personal computer (PC) may include a camera for capturing images of a surrounding environment to provide a variety of user experiences. For example, the electronic device may include at least one camera disposed on the front surface and/or rear surface thereof.

The electronic device may provide various functions for editing stored images. For example, the electronic device may provide a function for compositing multiple images into a single image as an example of an editing function. For example, the electronic device may also generate a video by using multiple images as an example of an editing function.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

When a user wants to composite multiple images on an electronic device, the user may be required to acquire each image, segment regions to be composited from each image, and combine the segmented regions. In order to obtain a final image through this process, a cumbersome compositing process is required, leading to inconsistent compositing effects and failing to reflect the characteristics of cameras used to capturing images.

Aspects of the disclosure are to address at least the above-mentioned problems and/or disadvantages and to provide at least the advantages described below. Accordingly, an aspect of the disclosure is to provide an electronic device and a method for capturing an image by an electronic device.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a display, a first camera having a first field of view, a second camera having a second field of view different from the first field of view, memory storing one or more computer programs, and one or more processors communicatively coupled to the display, the first camera, the second camera and the memory, wherein the one or more computer programs include computer-executable instructions that, when executed by the one or more processors individually or collectively, cause the electronic device to display, on the display, a first preview image including a first image having a first zoom magnification and acquired using the first camera, generate a first object image by extracting a first object included in the first image in response to a first user input while the first preview image is displayed, display, on the display, a second preview image obtained by overlaying the first object image on a second image having the first zoom magnification and acquired using the second camera, change the zoom magnification of the second image to a second zoom magnification, and display, on the display, a third preview image obtained by overlaying the first object image on the second image having the second zoom magnification, store a composite image corresponding to the displayed third preview image.

In accordance with an aspect of the disclosure, an electronic device is provided. The electronic device includes a display, a first camera, a second camera having a field of view different from that of the first camera, memory storing one or more computer programs, and one or more processors communicatively coupled to the display, the first camera, the second camera and the memory, wherein the one or more computer programs include computer-executable instructions that, when executed by one or more processors individually or collectively, cause the electronic device to display, on the display, a first preview image including a first image acquired using the first camera, generate a first object image associated with a first object among the first object and a second object included in the first preview image, display, on the display, a second preview image including the first object image and a second image acquired using the second camera, the second image including the second object, adjust and display the second image on the second preview image according to a selected magnification, and store a third image corresponding to the second preview image.

In accordance with another aspect of the disclosure, a method performed by an electronic device for capturing an image is provided. The method includes displaying, by the electronic device, a first preview image including a first image having a first zoom magnification and acquired using a first camera, generating, by the electronic device, a first object image by extracting a first object included in the first image in response to a first user input while the first preview image is displayed, displaying, by the electronic device, a second preview image obtained by overlaying the first object image on a second image having the first zoom magnification and acquired using a second camera having a field of view different from that of the first camera, changing, by the electronic device, the zoom magnification of the second image to a second zoom magnification and displaying a third preview image obtained by overlaying the first object image on the second image having the second zoom magnification, and storing, by the electronic device, a composite image corresponding to the displayed third preview image.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying, by the electronic device, a first preview image including a first image having a first zoom magnification and acquired using a first camera, generating, by the electronic device, a first object image by extracting a first object included in the first image in response to a first user input while the first preview image is displayed, displaying, by the electronic device, a second preview image by overlaying the first object image on a second image having the first zoom magnification and acquired using a second camera having a field of view different from that of the first camera, changing, by the electronic device, the zoom magnification of the second image to a second zoom magnification, and displaying a third preview image obtained by overlaying the first object image on the second image having the second zoom magnification, and storing, by the electronic device, a composite image corresponding to the displayed third preview image.

### Advantageous Effects of Invention

Various embodiments herein provide an electronic device and a method for capturing an image by an electronic device, wherein when a user wants to capture an image in which the ratio of a main subject and a background object has been adjusted using a camera of the electronic device, a photographing region can be automatically adjusted and an intuitive photographing experience for the image can be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a camera module according to an embodiment of the disclosure;

FIG. 3 illustrates cameras placed on a rear surface of an electronic device according to an embodiment of the disclosure;

FIG. 4 illustrates the process of capturing an image by an electronic device according to an embodiment of the disclosure;

FIG. 5 is a block diagram of an electronic device according to an embodiment of the disclosure;

FIGS. 6A and 6B illustrate images acquired using a first camera and a second camera of an electronic device according to various embodiments of the disclosure;

FIG. 7 is a flowchart of a method for executing a dynamic zoom mode by an electronic device according to an embodiment of the disclosure;

FIGS. 8A, 8B, and 8C illustrate a user interface (UI) provided when an electronic device executes a dynamic zoom mode according to various embodiments of the disclosure;

FIG. 9 is a flowchart of a method by which an electronic device composites a main subject and a background object and provides the composite as a preview according to an embodiment of the disclosure;

FIG. 10 illustrates a process in which an electronic device extracts a main subject from a first image according to an embodiment of the disclosure;

FIG. 11 illustrates a process in which an electronic device determines a zoom magnification corresponding to the boundary of a background object according to an embodiment of the disclosure;

FIGS. 12A, 12B, and 12C illustrate a process in which an electronic device changes a zoom magnification according to various embodiments of the disclosure;

FIGS. 13A and 13B illustrate a process in which an electronic device changes a zoom magnification according to various embodiments of the disclosure;

FIGS. 14A and 14B illustrate a process of acquiring an image according to various embodiments of the disclosure;

FIGS. 15A, 15B, and 15C illustrate a process in which an electronic device changes a zoom magnification according to various embodiments of the disclosure;

FIGS. 16A, 16B, and 16C illustrate a process in which an electronic device changes a zoom magnification according to various embodiments of the disclosure;

FIG. 17 is a flowchart of a method for processing and storing images of a main subject and a background object by an electronic device according to an embodiment of the disclosure; and

FIGS. 18A and 18B illustrate a process in which an electronic device matches feature points in a first image and a second image according to various embodiments of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

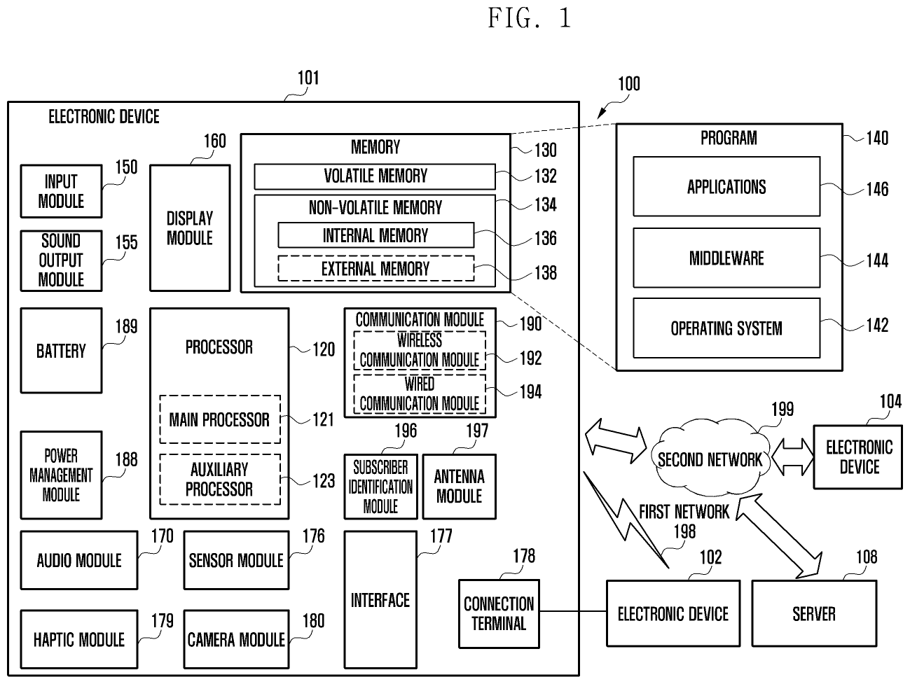

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

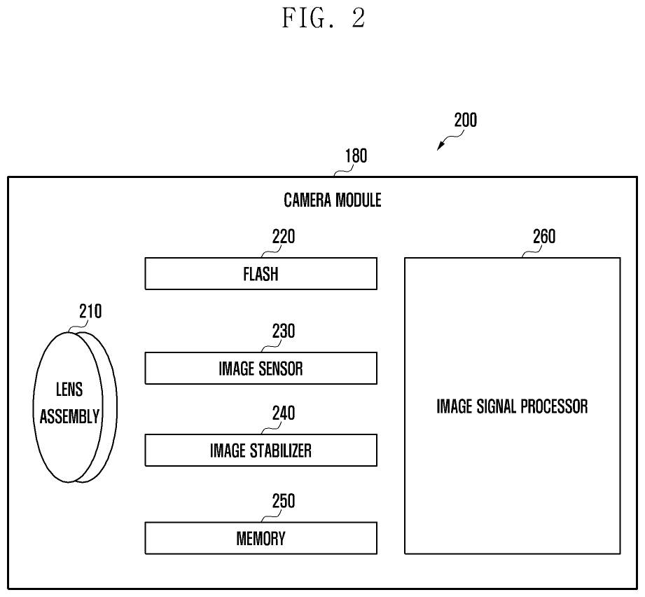

FIG. 2 is a block diagram illustrating a camera module, according to an embodiment of the disclosure.

Referring to FIG. 2, in a block diagram 200, the camera module 180 may include a lens assembly 210, a flash 220, an image sensor 230, an image stabilizer 240, memory 250 (e.g., buffer memory), or an image signal processor 260. The lens assembly 210 may collect light emitted from a subject that is a target of image capturing. The lens assembly 210 may include one or more lenses. According to an embodiment, the camera module 180 may include multiple lens assemblies 210. In this case, the camera module 180 may form, for example, a dual camera, a 360-degree camera, or a spherical camera. Some of the multiple lens assemblies 210 may have the same lens properties (e.g., field of view, focal length, autofocus, f number, or optical zoom), or at least one lens assembly may have one or more lens properties that differ from the lens properties of the other lens assemblies. The lens assemblies 210 may include, for example, a wide-angle lens or a telephoto lens

According to an embodiment, the flash 220 may emit light that is used to enhance light emitted or reflected from a subject. According to an embodiment, the flash 220 may include one or more light-emitting diodes (e.g., red-green-blue (RGB) light-emitting diodes (LEDs), white LEDs, infrared LEDs, or ultraviolet (UV) LEDs), or a xenon lamp. The image sensor 230 may convert light emitted or reflected from a subject and transmitted through the lens assemblies 210 into an electrical signal, thereby acquiring an image corresponding to the subject. According to an embodiment, the image sensor 230 may include one image sensor selected from image sensors having different properties, such as an RGB sensor, a black and white (BW) sensor, an IR sensor, or a UV sensor, multiple image sensors having the same properties, or multiple image sensors having different properties. Each image sensor included in the image sensor 230 may be implemented using, for example, a charged coupled device (CCD) sensor or a complementary metal oxide semiconductor (CMOS) sensor.

The image stabilizer 240 may, in response to movement of the camera module 180 or the electronics 101 including the same, may move at least one lens included in the lens assemblies 210 or the image sensor 230 in a specific direction or may control the operation characteristics of the image sensor 230 (e.g., adjust a read-out timing). This may compensate for at least some of negative effects of the movement on an image being captured. According to an embodiment, the image stabilizer 240 may detect such movements of the camera module 180 or the electronic device 101 by using a gyro sensor (not shown) or an acceleration sensor (not shown) disposed inside or outside the camera module 180. According to an embodiment, the image stabilizer 240 may be implemented as, for example, an optical image stabilizer. The memory 250 may at least temporarily store at least a portion of an image acquired via the image sensor 230 for the next image processing operation. For example, when image acquisition by a shutter is delayed, or when multiple images are acquired at high speed, the acquired original image (e.g., a Bayer-patterned image or a high-resolution image) may be stored in the memory 250, and a corresponding copy image (e.g., a low-resolution image) may be previewed via the display device 160. Subsequently, when a specified condition is satisfied (e.g., a user input or a system command), at least a portion of the original image stored in the memory 250 may be acquired and processed, for example, by the image signal processor 260. According to an embodiment, the memory 250 may be configured as at least part of the memory 130, or as separate memory operating independently of the memory 130.

The image signal processor 260 may perform one or more image processing operations on images acquired via the image sensor 230 or images stored in the memory 250. The one or more image processing operations may include, for example, generating a depth map, three-dimensional modeling, panorama generation, feature point extraction, image compositing, or image compensation (e.g., noise reduction, resolution adjustment, brightness adjustment, blurring, sharpening, or softening). Additionally or alternatively, the image signal processor 260 may control at least one (e.g., the image sensor 230) of the components included in the camera module 180 (e.g., control exposure time, or control read-out timing). The image processed by the image signal processor 260 may be stored back in the memory 250 for additional processing or provided to a component (e.g., the memory 130, the display device 160, the electronic device 102, the electronic device 104, or the server 108) outside the camera module 180. According to an embodiment, the image signal processor 260 may be configured as at least a portion of the processor 120, or may be configured as a separate processor operating independently of the processor 120. When the image signal processor 260 is configured as a processor separate from the processor 120, at least one image processed by the image signal processor 260 may be displayed via the display device 160 as is or after additional image processing by the processor 120.

According to an embodiment, the electronic device 101 may include multiple camera modules 180 having different properties or functions. In such a case, for example, at least one of the multiple camera modules 180 may be a wide-angle camera and at least one other may be a telephoto camera. Similarly, at least one of the multiple camera modules 180 may be a front camera, and at least one other may be a rear camera.

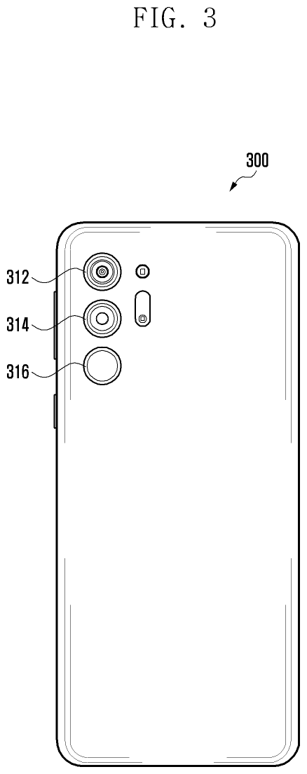

FIG. 3 illustrates cameras disposed on a rear surface of an electronic device according to an embodiment of the disclosure.

According to an embodiment, an electronic device 300 may include at least one front camera disposed on the front surface of a housing on which a display (e.g., the display module 160 of FIG. 1) is disposed, and at least one rear camera disposed on the rear surface of the housing on which a rear cover is disposed.

Referring to FIG. 3, the electronic device 300 may include three cameras (e.g., a first camera 312, a second camera 314, and a third camera 316) disposed adjacent to each other on the rear surface (e.g., the rear left top) of the housing, but the number and/or positioning of the cameras is not limited thereto. The first camera 312, the second camera 314, and the third camera 316 may include at least some of the components and/or functions of the camera module 180 of FIG. 1 and/or the camera module 180 of FIG. 2. According to an embodiment, the first camera 312, the second camera 314, and the third camera 316 may be disposed adjacent to each other, thereby capturing an image in substantially the same direction.

According to an embodiment, the first camera 312, the second camera 314, and the third camera 316 may have different optical characteristics. For example, the first camera 312, the second camera 314, and the third camera 316 may differ in at least some of lens optical characteristics, such as field of view, focal length, aperture, or material, structure, refractive index of lens, or refractive/diffractive properties of lens, and/or at least some of sensor characteristics, such as sensor pitch or the number of pixels.

According to an embodiment, the first camera 312, the second camera 314, and the third camera 316 may capture images with different field of views. As used herein, a field of view may refer to the range of a scene that a camera can capture at one time. For example, the first camera 312 may be an ultra-wide camera (or an ultra-wide (UW) camera) that captures an image with a very wide field of view (e.g., about 120 degrees), the second camera 314 may be a wide-angle camera (or a wide (W) camera) that capture an image with a wide field of view (e.g., about 84 degrees), and the third camera 316 may be a telephoto camera (or a telescope (T) camera) that captures an image with a narrow field of view (e.g., about 20 degrees). Accordingly, when the electronic device captures the same scene by using the first camera 312 and the second camera 314, the first camera 312 may capture the scene with a relatively wide field of view, causing a specific subject to appear smaller, and the second camera 314 may capture the scene with a relatively narrow field of view, causing the specific subject to appear larger.

According to an embodiment, the electronic device 300 may activate one of the first camera 312, the second camera 314, or the third camera 316 when a camera application (or an application that uses camera resources) is executed, and the electronic device 300 may display an image acquired by the camera on the display in real time as a preview (or viewfinder).

According to an embodiment, when the camera application is executed, the electronic device 300 may provide a user interface (UI) for configuring a zoom magnification. For example, the UI may be provided as selectable items corresponding to multiple zoom magnifications (e.g., ×0.6, ×1.0, ×3.0), may be provided in the form of a scrollable bar which enables selecting a specific zoom magnification, and/or may be provided such that the zoom magnification is adjustable in response to a user's multi-touch interaction (e.g., pinch to zoom). According to an embodiment, the electronic device 300 may acquire an image at a default zoom magnification (e.g., ×1.0) during execution of the camera application, and may change the zoom magnification based on a user input via the UI.

According to an embodiment, the electronic device 300 may provide hybrid zoom function. Here, the hybrid zoom function may include analog optical zoom and digital zoom (or digital crop zoom), such that analog optical zoom is used in some zoom magnification ranges, while digital zoom is used in other zoom magnification ranges. Analog optical zoom may involve using a camera lens and an optical element to enlarge or reduce the field of view. Digital zoom may be a method of enlarging or reducing the field of view of a displayed or stored image by cropping a portion of an original image, acquired from the image sensor, through digital processing of the acquired original image without changing an optical element. For example, the first camera 312, the second camera 314, and the third camera 316 may acquire original images with an analog optical zoom magnification of ×0.6, ×1.0, and ×5.0, respectively, and the electronic device 300 may acquire an image by using the first camera 312 in ranges (e.g., ×0.6 to ×1.0) where the current zoom magnification is less than the optical zoom magnification (e.g., ×1.0) of the second camera 314, may acquire an image by using the second camera 314 in ranges (e.g., ×1.0 to ×5.0) where the current zoom magnification is equal to or greater than the optical zoom magnification of the second camera 314 and less than the optical zoom magnification (e.g., ×5.0) of the third camera 316, and may acquire an image by using the third camera 316 in ranges (e.g., ×5.0 to ×30.0) where the current zoom magnification is equal to or greater than the optical zoom magnification of the third camera 316. The electronic device 300 may, in response to the currently configured zoom magnification, crop a portion of the acquired image and display the cropped portion as a preview image, and when the zoom magnification is changed, the electronic device 300 may change the size of a region to be cropped from the image.

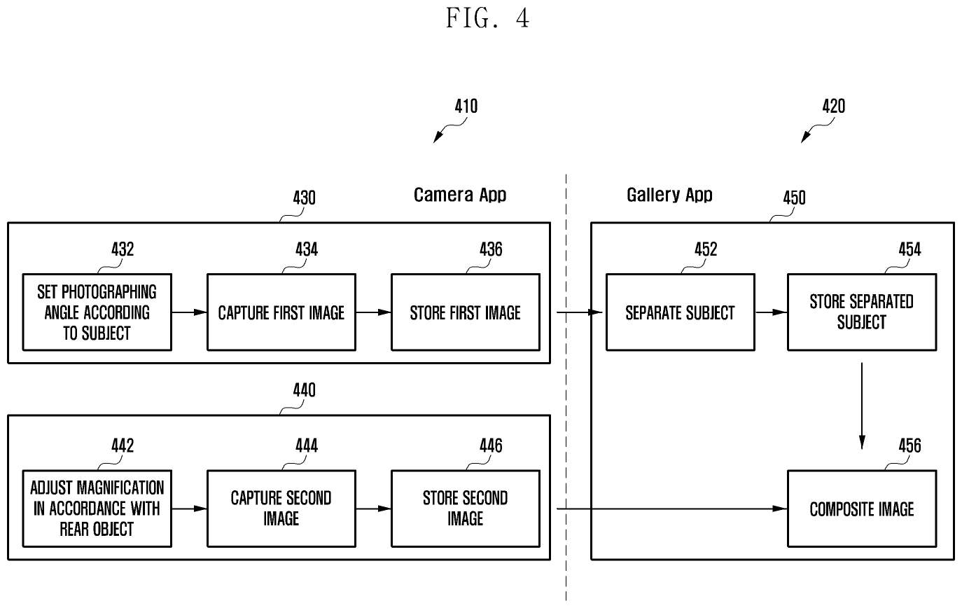

According to an embodiment, the electronic device 300 may provide a dynamic zoom function. The dynamic zoom function herein may refer to a function of fixing the size (or zoom magnification) of at least one subject (e.g., a main subject) in an image and reducing or enlarging other objects (e.g., background objects) through zooming-in or zooming-out. For example, the electronic device 300 may select at least one camera from among the cameras 312, 314, and 316 to acquire an image including a main subject (or a first object), extract and separate a region of the main subject from the acquired image, select at least one camera from among the cameras 312, 314, and 316 to acquire an image including a background object (or a second object), and then composite the separated region of the main subject and the image of the background object. According to an embodiment, the electronic device 300 may provide a dynamic zoom function while displaying a preview image from the camera. Hereinafter, various embodiments related to the dynamic zoom function provided by the electronic device 300 will be described with reference to FIGS. 4, 5, 6A and 6B, 7, 8A to 8C, 9 to 11, 12A to 12C, 13A and 13B, 14A and 14B, 15A to 15C, 16A to 16C, 17, and 18A and 18B.

FIG. 4 illustrates a process of compositing images captured by an electronic device according to an embodiment of the disclosure.

Referring to FIG. 4, an embodiment of generating a composite image by adjusting the ratio of a main subject and a background object in multiple (e.g., two) images, which have been independently captured and stored, and then compositing the images is illustrated. For example, when a main subject and a background object located farther than the main subject are present in a photographed scene, a user may want to adjust the size of the main subject and/or the background object differently from the actual size thereof. For example, the electronic device may store multiple (e.g., two) images captured using at least one of multiple cameras (e.g., the first camera 312, the second camera 314, and the third camera 316 in FIG. 3) and generate a composite image by increasing or reducing the size of the main subject and/or the background object based on the user's editing and/or correction on a gallery application 420.

According to an embodiment, the electronic device may provide a function of, on the gallery application 420, separating (or segmenting) a specific object from a single image and then enlarging and compositing the specific object based on a user input. For example, the electronic device may separate, based on a user input, a specific object from an image acquired via any one of multiple cameras (e.g., the first camera 312, the second camera 314, and the third camera 316 in FIG. 3) based on user input, enlarge the separated object, and composite the separated object into the original image. This embodiment may only allow for substantially increasing the size of the separated object, may require the user to go through multiple operations during the image editing process, and/or may result in a decrease in image quality as the size of the object increases.

According to an embodiment, the electronic device may provide a function of, on the gallery application 420, separating a specific object from a single image, enlarging or reducing the separated object based on a user input, and compositing the separated object by using the function of generative AI. In this embodiment, when the specific object is reduced, the empty space is filled not by reflecting actual image information but by retrieving information from other images using generative AI, thus causing unnatural parts in the composite image.

According to an embodiment, the electronic device may provide a function of, on the gallery application 420, separating a specific object from the first image and then compositing the separated object onto a second image. For example, the electronic device may use at least one (e.g., two) of multiple cameras to acquire a first image and a second image having different angles of view and/or zoom magnifications. Based on a user input, the electronic device may separate a specific object from the first image and then composite the separated objects onto the second image. This embodiment may reflect the complex needs of a user, but may require the user to go through multiple operations, as this embodiment based on post-capture correction.

FIG. 4 illustrates operations of capturing and compositing the first image and the second image in the above-described embodiments.

According to an embodiment, the electronic device may perform an operation 430 of capturing and storing a first image by using a camera application 410 in response to a user input. For example, with one of the cameras (e.g., the first camera, the second camera, and the third camera in FIG. 3) of the electronic device activated, the electronic device may configure a photographing angle suitable for a position of a main subject (e.g., a person) (432), capture the first image including the subject in response to a user input on a photographing button (434), and store the first image (436).

According to an embodiment, the electronic device may perform an operation 440 of capturing and storing a second image before or after the operation 430 of capturing and storing the first image. For example, with one of the cameras of the electronic device activated, the electronic device may adjust a zoom magnification such that a background object is included in the image (442), capture the second image including the subject in response to a user input on the photographing button (444), and store the second image (446).

According to an embodiment, the electronic device may perform operation 450 of compositing the first and second stored images on the gallery application 420. For example, the electronic device may execute the gallery application 420 and, based on user input, select the first image including the main subject and the second image including the background object. The electronic device may separate the main subject from the first image (436) and store the separated main subject image (454). The electronic device may composite the separated main subject image and the second image (456).

According to an embodiment, the second image may be an image having a field of view and/or zoom magnification different from that of the first image. Alternatively, the electronic device may increase or reduce the size of the second image based on a user input. Accordingly, the composite image may have a ratio of the main subject to the background object different from the ratio of the main subject to the background object in an actual photographed scene.

In order to implement the function of adjusting the ratio between the main subject and the background object, such as in the embodiment of FIG. 4, the electronic device may go through an operation 450 of: separately capturing and storing an image containing the main subject and an image containing the background object; generating and storing an image through an additional operation of separating the subject in the gallery application 420; and then compositing the separated subject image onto the background object image again. As such, the ratio adjustment process requires multiple procedures, and a user can identify the composite image only after completing the entire editing process, thereby making immediate identification difficult. Furthermore, when compositing the separated subject and the background object, heterogeneous parts may occur at the boundary line therebetween. Furthermore, when images captured using different cameras are composited, the size, ratio, or perspective of each object may vary depending on the optical characteristics of each camera, thereby making it insufficient to meet the complex needs of the user.

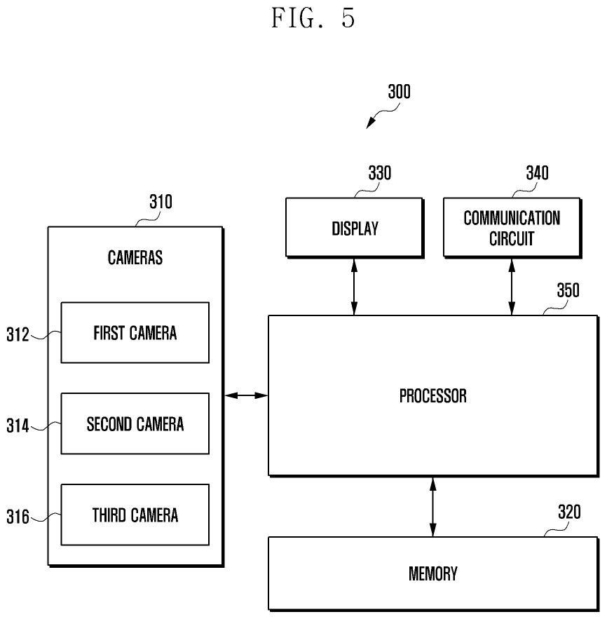

FIG. 4 may be a comparative example of an image capturing method using a dynamic zoom function described in FIG. 5 and below. However, the disclosure in FIG. 4 is not recognized as prior art.

According to an embodiment, the electronic device may perform processes of separating a main subject from the first image and the second image acquired using the dynamic zoom function (452), storing the separated main subject image (454), and compositing the images (456).

FIG. 5 is a block diagram of an electronic device according to an embodiment of the disclosure.

Referring to FIG. 5, an electronic device 300 according to various embodiments may include multiple cameras 310, a display 330, a communication circuit 340, a processor 350, and memory 320. Various embodiments herein may be implemented even when at least some of the illustrated components are omitted or substituted with other components. In addition to the illustrated components, the electronic device 300 may further include at least some of the components and/or functions of the electronic device 101 of FIG. 1. At least some (e.g., the communication circuit 340, the processor 350, and the memory 320) of the components of the electronic device 300 which are illustrated (or not illustrated) may be disposed in a housing of the electronic device 300, and at least some of the other components (e.g., the display 330 and the cameras 310) may be at least partially visually exposed to the outside of the housing. At least some of the components of the electronic device 300 may be operatively, functionally, and/or electrically connected to each other.

According to an embodiment, the display 330 may display image information provided by the processor 350. The display 330 may be implemented as any one among a liquid crystal display (LCD), a light-emitting diode (LED) display, and an organic light-emitting diode (OLED) display but is not limited thereto. The display 330 may be configured as a touch screen that senses touch and/or proximity touch (or hovering) input using a part (e.g., a finger) of the user's body or an input device (e.g., a stylus pen). The display 330 may include at least some of the components and/or functions of the display module 160 of FIG. 1.

According to an embodiment, the display 330 may be a flexible display that is at least partially flexible. The electronic device 300 may be implemented in various form factors, such as a foldable device or a rollable device in which the size of the display region may be changed by utilizing the characteristics of a flexible display.

According to an embodiment, the electronic device 300 may include at least one camera on each of the front and/or rear surfaces thereof. As described with reference to FIG. 3, the electronic device 300 may include three cameras (e.g., a first camera 312, a second camera 314, and a third camera 316) on the rear surface of the housing on which a rear cover is disposed, but the number of cameras included in the electronic device 300 is not limited thereto. Herein, the electronic device 300 is described as including the first camera 312, the second camera 314, and the third camera 316. However, various embodiments herein may be implemented even when the electronic device includes two cameras or four or more cameras. Furthermore, herein, although the dynamic zoom function is described as being implemented using at least one of the cameras 312, 314, and 316 disposed on the rear surface of the electronic device. However, the dynamic zoom function may be also implemented by further using an image acquired by a camera (not shown) disposed at the front surface or an external camera (not shown) that is connected in a wired or wireless manner.

According to an embodiment, the cameras 310 may further include at least some of the functions and/or components of the camera module 180 of FIG. 2, such as the lens assembly 210, the flash 220, the image sensor 230, the image stabilizer 240, the memory 250, and the image signal processor 260.

According to an embodiment, the cameras 312 may be disposed adjacent to each other to capture an image in substantially the same direction. Accordingly, the change in field of view of an image provided via a preview may be substantially continuous even when the zoom magnification switches from a digital zoom range of the first camera 312 to the analog optical zoom magnification of the second camera 314, and from the digital zoom range of the second camera 314 to the analog optical zoom magnification of the third camera 316.

According to an embodiment the cameras 310 may capture images of different angles of view. For example, the first camera 312 may be an ultra-wide-angle camera (or an ultra-wide (UW) camera) that capture an image with a very wide field of view (e.g., about 120 degrees), the second camera 314 may be a wide-angle camera (or a wide (W) camera) that captures an image with a wide field of view (e.g., about 84 degrees), and the third camera 316 may be a telephoto camera (or a telescope (T) camera) that capture an image with a narrow field of view (e.g., about 20 degrees). Accordingly, when the electronic device 300 use the first camera 312 and the second camera 314 to photograph the same scene to be photographed, the first camera 312 may photograph the scene with a relatively wide field of view, causing a specific subject to appear smaller, and the second camera 314 may photograph the scene with a relatively narrow field of view, causing the specific subject to appear larger.

According to an embodiment, the memory 320 may include volatile memory and non-volatile memory, and temporarily or permanently store various types of data. The memory 320 may include at least some of the components and/or functions of the memory 130 of FIG. 1, and may store the program 140 of FIG. 1. The memory 320 may store various instructions which can be executed by the processor 350. The instructions may include control commands related to arithmetic and logical operations, data movement, input/output, etc., which can be recognized by the processor 350.

According to an embodiment, the processor 350 may be configured to perform operations or data processing related to control and/or communication of the components of the electronic device 300, and may include one or more processors. For example, the processor 350 may correspond to multiple processors that collectively perform multiple operations, which are distributed among the processors. The processor 350 may include at least some of the components and/or functions of the processor 120 of FIG. 1. Computation and data processing functions that the processor 350 can implement on the electronic device 300 are not limited. However, various embodiments for compositing and capturing a main subject image and an image including a background object will be described in detail herein. The operations of the processor 350 that will be described later may be performed by loading the instructions stored in the memory 320.

A description herein that the processor 350 is capable of performing an operation (or function, work, or task) may also be interpreted as having substantially the same meaning as a description that an instruction (or a command or a computer program) that cause the electronic device 300 (or the processor 350) to perform the operation is stored in the memory 320 (e.g., non-volatile memory or a storage). Additionally, a description that the processor 350 is capable of performing an operation may be interpreted as having substantially the same meaning as a description that at least one unspecified processor is capable of performing the operation.

According to an embodiment, the electronic device 300 may provide a dynamic zoom function via a camera application or another application that uses a camera resource. Herein, dynamic zoom function may refer to the function of fixing the size of a specific object (e.g., a main subject) in an image through image compositing, while adjusting the size of other objects (e.g., background objects) or other remaining regions of the image through zooming-in or zooming-out.

According to an embodiment, when the camera application is executed, the processor 350 may activate one of the first camera 312, the second camera 314, and the third camera 316, and display a preview image, which includes an image acquired in real time using the activated camera, on the display 330. For example, in response to the execution of the camera application, the processor 350 may activate the second camera 314 (e.g., a wide camera), which is configured to a default, to display a preview image on the display 330 at a predetermined zoom magnification (e.g., ×1.0).

According to an embodiment, the processor 350 may execute a dynamic zoom mode when an image being acquired through the activated camera satisfies a specified condition. According to an embodiment, when the specified condition is satisfied, the processor 350 may display an item, which may trigger the dynamic zoom mode, on the display 330, and may execute the dynamic zoom mode based on a user input on the item. Alternatively, when the specified condition is satisfied, the processor 350 may execute the dynamic zoom mode directly without any additional user input.

According to an embodiment, the specified condition for triggering the dynamic zoom mode may include whether the image acquired by the activated camera includes the entire region of a main subject (or a first object) and a partial region of a background object (or a second object). Here, the background object may be an object positioned behind the main subject with respect to the electronic device 300. For example, when a specific person is positioned in front of a specific building in a scene to be photographed, and when capturing an image centered on the person is intended, the entire region or a partial region of the building may be formed in the image depending on the distances between the electronic device 300 and the person and between the electronic device and the building, the size of the building, and/or the field of view of the activated camera. In this case, only a partial region of the background object (e.g., the building) may be formed in the image when the image is captured using the second camera 314 or the third camera 316, among the cameras 310 of the electronic device 300, which has a relatively narrow field of view, and the entire region of the background object may be formed in the image when the image is captured using the first camera 312 which has a relatively wide field of view. When the entire region of the main subject and the entire region of the background object are included within the field of view of the acquired image, the processor 350 may proceed with the photographing process in normal mode, and when the entire region of the main subject and a partial region of the background object are included within the field of view (or when a partial region of the outer periphery of the background object is cropped), the processor 350 may directly execute the dynamic zoom mode or may provide a UI for executing the dynamic zoom mode.

According to an embodiment, when a boundary line of the background object is not recognized in the image, the processor 350 may determine that a partial region of the background object is included in the image. For example, the processor 350 may use at least one of various edge detection algorithms to identify whether the boundary line of the background object is included in the image.

According to an embodiment, the processor 350 may determine whether the entire region or a partial region of the background object is formed within the image, by using continuity of pixel data of image pixels or by using techniques for identifying the type of object and the shape of the object by type.

According to an embodiment, the specified condition for triggering the dynamic zoom mode may be based on the type of scene in a captured image, and/or the type of object included in the image. For example, in terms of the type of scene, the processor 350 may determine whether a photo a user is attempting to take is a landscape, portrait, animal, sports, panoramic, night view, party, nature, urban, indoor, or outdoor photograph. Furthermore, the processor 350 may determine, as a type of object in the image, whether each of at least one object included in the image is a person, animal, building, sky, sea, mountain, or an object (e.g., car, airplane, bag, or clothing). The processor 350 may trigger the dynamic zoom mode when the recognized scene is one of predetermined types (e.g., landscape, night scene, nature, outdoor, etc.), the main subject is one of predetermined types (e.g., person, animal, etc.), and/or the background object is one of predetermined types (e.g., building, mountain, tree, etc.). According to an embodiment, the processor 350 may trigger the dynamic zoom mode based further on the composition of the acquired image. For example, the processor 350 may identify whether the composition of the acquired image is a central composition in which the main subject is positioned in the center of a screen, a split composition in which the main subject is divided and arranged either vertically or horizontally, or a composition that is a combination of a central composition and a split composition.

According to an embodiment, the processor 350 may recognize whether a background object corresponds to a predetermined landmark, based on current position information of the electronic device 300 and/or image information acquired through the cameras. When the background object corresponds to the predetermined landmark, the processor 350 may execute a dynamic zoom mode and recommend a photographing position or posture suitable for photographing the landmark.

According to an embodiment, the processor 350 may provide a UI indicating the dynamic zoom mode when the dynamic zoom mode is executed. For example, the processor 350 may overlay an item indicating the dynamic zoom mode on the preview image, and/or display the item indicating the dynamic zoom mode via a mode configuration UI.

According to an embodiment, when the dynamic zoom mode is executed, the processor 350 may select a currently activated camera as a primary camera to acquire a first image. Hereinafter, among the cameras 310 of the electronic device 300, a camera that captures a first image including a main subject and a partial region of a background object in the dynamic zoom mode may be defined as a primary camera, and a camera that captures a second image including the main subject and the entire region of the background object after the first image has been captured may be defined as a secondary camera. For example, the electronic device 300 may use at least one of the first camera 312, the second camera 314, or the third camera 316 as the primary or secondary camera. Alternatively, the electronic device 300 may use at least one external camera that is connected to the electronic device in a wired or wireless manner as the primary or secondary camera. According to an embodiment, the processor 350 may select a camera having a wider field of view than the primary camera as the secondary camera. In another embodiment, the electronic device may use one camera as each of the primary camera and the secondary camera.

According to an embodiment, the processor 350 may display, on the display 330, a first preview image that includes a first image having a first zoom magnification and acquired using the primary camera. According to an embodiment, the processor 350 may use a camera that was activated before the execution of the dynamic zoom mode as a primary camera, and may maintain the previous zoom magnification even when the dynamic zoom mode is executed.

According to an embodiment, the processor 350 may select a secondary camera to be used in the dynamic zoom mode among the cameras 310. According to an embodiment, the processor 350 may select a camera, among the cameras 310, which has a wider field of view than the primary camera (or the currently activated camera) as the secondary camera. For example, when the second camera 314 (or the W camera) acquires an image as a primary camera and displays the image as a preview image, the processor 350 may select the first camera 312 (or the UW camera), having a wider field of view than the second camera 314 (or the W camera), as a secondary camera.

According to an embodiment, the processor 350 may select a camera, among the cameras 310, which can include a larger region of a background object than a primary camera, as a secondary camera. For example, the processor 350 may select, as a secondary camera, a camera, among the cameras 310, which can include the entire region of a background object in an image, but is not limited thereto. The processor 350 may identify which of the cameras 310 that can be provided by the electronic device 300 at the current location can include a larger region (e.g., the entire shape) of a background object in an image when considering the field of view and/or magnification. For example, when a first image, acquired by the third camera 316 (or the T camera) as a primary camera, includes a main subject and a partial region of a background object, the processor 350 may activate the second camera 314 (or the W camera) in the background to acquire an image. When the image acquired through the second camera 314 does not include the entire region of the background object, or when at least a portion of a boundary line of the background object is not included in the image, the processor 350 may activate the first camera 312 (or the UW camera) in the background to acquire an image. When the image acquired through the first camera 312 includes the entire region of the background object, the processor 350 may determine that the first camera 312 is a secondary camera.

According to an embodiment, the processor 350 may identify the composition and/or aspect ratio of an image by using at least one among the depth of field of the image, the distance between a main subject and a background object, the distances between the electronic device 300 and the main subject and the background object, the percentage of a region in the image occupied by each of the main subject and background object, and the size difference between multiple objects, and compare the composition and/or aspect ratio of the image with a reference composition and/or aspect ratio that is pre-stored based on the type of scene and/or object. The reference composition and/or aspect ratio may be stored as table-like values that take into account the position of objects in the image based on a reference image or the size and/or resolution of the image. The processor 350 may select, as a secondary camera, a camera, among the cameras 310, which is capable of acquiring image information of the background object in accordance with the reference composition and/or aspect ratio.

According to an embodiment, when there is no camera that can include the entire region of the background object in the image, the processor 350 may use the display 330 to provide a movement guide UI for guiding a user of the electronic device 300 to move. For example, the processor 350 may analyze an image acquired by each camera to identify a direction in which and a distance by which the position of the electronic device 300 should be moved to include the entire shape of the background object in the image. The processor 350 may provide the identified direction and/or distance of movement to the user via the movement guide UI on a preview image. The movement guide UI may include graphical elements that indicate a movement direction, a distance, an angle, a height, and/or the shape of an object to be included in the field of view changing during movement. As the user of the electronic device 300 moves in accordance with the movement guide UI, a specific camera may be able to capture the entire region of the background object, and that camera may be selected as a secondary camera.

According to an embodiment, the processor 350 may capture an image by applying composition based on the type of scene and/or object the user intends to photograph, an object-specific size, and an object-specific aspect ratio. For example, the processor 350 may identify whether a photo to be taken is the photo of a person or a specific object (e.g., flower or food), and may select a primary and/or secondary camera and/or adjust the zoom magnification of the primary and/or secondary camera so that a final photo is taken in consideration of a recommended framing for a main subject and/or a recommended framing for a background object.

According to an embodiment, while a first preview image, including a first image acquired using a primary camera, is being displayed on the display 330, the processor 350 may, based on a user input, capture and store the first image. For example, the user input for capturing the image may include a touch input on a photographing button, voice input, etc.

According to an embodiment, the processor 350 may extract a main subject (or a first object) from the first image (or the first preview image) to generate a main subject image (or a first object image). The processor 350 may use an object segmentation function to separate the main subject (e.g., a person) from the first image. According to an embodiment, the processor 350 may identify objects included in an image acquired through the currently activated camera and identify the region of a main subject. For example, the processor 350 may use various object detection algorithms based on deep learning, such as region-based convolutional neural networks (R-CNNs), you only look once (YOLO), and single shot multibox detector (SSD), to identify objects included in the image. The processor 350 may store the main subject image generated from the first image in the memory 320.

According to an embodiment, when the first image is captured in response to the user input, the processor 350 may display, on the display 330, a second preview image that includes the main subject image acquired from the first image and a second image acquired in real time through a secondary camera. The processor 350 may maintain a zoom magnification in a second preview image at the same zoom magnification (e.g., a first zoom magnification) as the zoom magnification in the first preview image when switching from the first preview image to the second preview image. For example, when the first image was captured at a zoom magnification of ×1.0 by using the second camera 314 which is a primary camera, the processor 350 may configure the zoom magnification of the first camera 312, which is a secondary camera, to ×1.0 and crop an image acquired by the first camera 312 to correspond to ×1.0 for display. When switching to the second preview image, the zoom magnification is the same as that of the first preview image, and thus a user may not experience a sense of disparity, and the main subject may also be displayed at substantially the same size.

According to an embodiment, the processor 350 may, at least partially concurrently with the display of the second preview image, display a guideline related to capturing the second image to the user via the display 330. For example, the guideline may include an outline that indicate an allowable range of shake of the electronic device 300 or a range within which a main subject should be positioned.

According to an embodiment, the processor 350 may adjust the zoom magnification of the second preview image to display a third preview image having a second zoom magnification. In this case, the processor 350 may fix the main subject image and adjust only the zoom magnification of the second image that includes the background objects. The processor 350 may provide an image change in real time via the display 330 in response to a change in the zoom magnification of the second image. In this case, the preview image is a composite of the second image having the zoom magnification changing in real time and the main subject image having a fixed size, so that the main subject may be displayed in the same position despite the change in zoom magnification. The processor 350 may adjust the zoom magnification of the second preview image according to a manual zoom mode or an automatic zoom mode.

According to another embodiment, the processor 350 may also change the size (or zoom magnification) of the main subject image in the process of adjusting the zoom magnification of the second preview image. In this case, the processor 350 may change the size (or zoom magnification) of the main subject image by a smaller amount of change than a change in the size (or zoom magnification) of the second image.

According to an embodiment, when configured to a manual zoom mode, the processor 350 may provide, via the display 330, a zoom configuration UI that allows the zoom magnification to be configured at least partially concurrently with the display of the second preview image. For example, the zoom configuration UI may be provided as selectable items corresponding to multiple zoom magnifications (e.g., ×0.6, ×1.0, ×3.0), may be provided in the form of a scrollable bar from which a specific zoom magnification may be selected, and/or may be provided such that the zoom magnification is adjustable in response to multi-touch interaction (e.g., pinch to zoom) by the user.

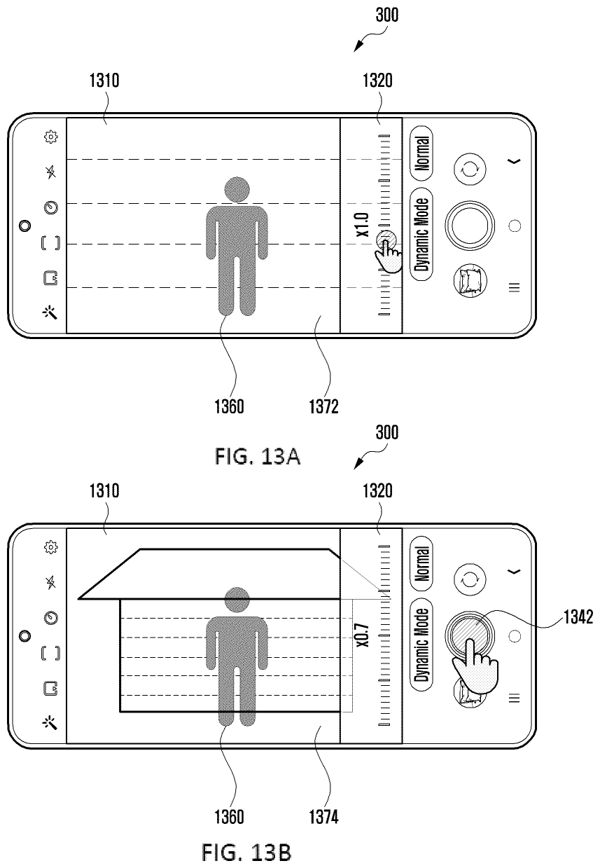

According to an embodiment, the processor 350 may adjust, based on a user input, the zoom magnification of an image acquired from a secondary camera, and overlay and display a main subject image. According to an embodiment, the size of the main subject may be overlaid and displayed at a fixed size. According to another embodiment, the size of the main subject may be overlaid while changing in response to adjustment of the zoom magnification, but changing by a smaller amount of change than a change in size of the image acquired by the secondary camera. According to an embodiment, the processor 350 may adjust the zoom magnification based on the user input and then capture the image acquired by the secondary camera, based on a user input on a photographing button. The process of changing a preview screen in the manual zoom mode will be described in more detail with reference to FIGS. 13A and 13B.

According to an embodiment, when configured to automatic zoom mode, the processor 350 may determine a second zoom magnification to be applied to the second image, based on a background object included in the second image captured by the secondary camera. According to an embodiment, the processor 350 may determine the second zoom magnification as one of zoom magnifications at which the entire region of the background object included in the second image can be displayed. According to an embodiment, the processor 350 may determine the second zoom magnification as the maximum zoom magnification at which the entire region of the background object included in the second image can be displayed. For example, at the first zoom magnification, only a portion of the background object may be included in the second preview image, and the processor 350 may gradually decrease the zoom magnification from the first zoom magnification to identify a zoom magnification at which the boundary line of the background object can be formed within the preview image. According to an embodiment, the second zoom magnification to be applied to the second image may be determined based on a guide or reference composition provided by the electronic device 300.

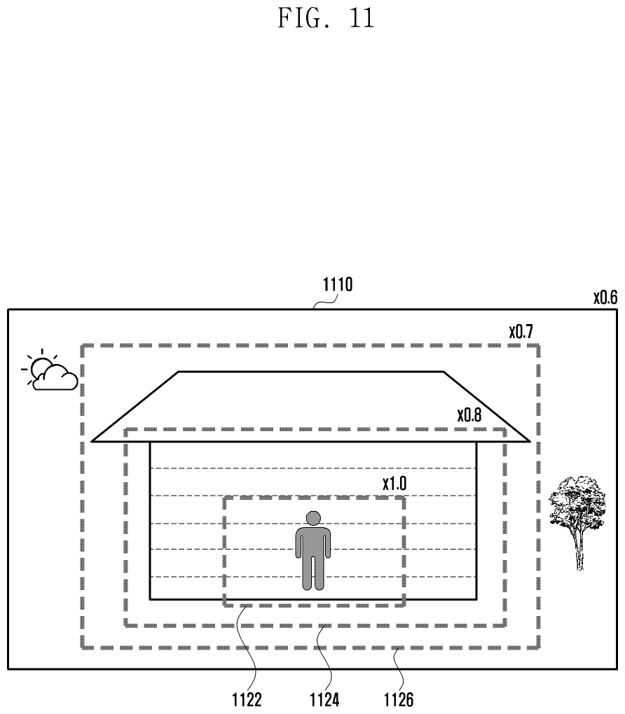

According to an embodiment, the processor 350 may determine the second zoom magnification by a binary search using the first zoom magnification and the optical zoom magnification of the secondary camera. For example, when the user captured the first image while the first zoom magnification of the first preview image is ×1.0, the processor 350 may identify a maximum zoom magnification at which the boundary line of the background object can be formed in the preview image, by using a binary search using ×0.6, which is the optical zoom magnification of the secondary camera (e.g., the UW camera), and ×1.0, which is the first zoom magnification. The processor 350 may crop an image to a size corresponding to ×0.8, which is an intermediate value between ×0.6 and ×1.0, and identify whether the boundary line of the background object is formed within the image of ×0.8. When the boundary line of the background object is not formed within the image of ×0.8, the processor 350 may crop an image to a size corresponding to ×0.7, which is an intermediate value between ×0.6 and ×0.8, and identify whether the boundary line of the background object is formed. When a zoom magnification at which the boundary line of the background object is formed is identified during the binary search, the processor may identify whether the boundary line of the background object is formed in an image with an intermediate value between the identified zoom magnification and a larger zoom magnification, and through this process, the processor may identify the maximum zoom magnification at which the boundary line of the background object is formed. The method for determining the second zoom magnification by using the binary search will be described in more detail with reference to FIG. 11.

According to an embodiment, the processor 350 may determine the second zoom magnification in consideration of the size of a main subject, the position thereof, the distance between the main subject and a background object, or features of the background object. For example, when the background object includes specific text or a characteristic shape, the processor 350 may determine the second zoom magnification as the zoom magnification at which the text or the shape can have at least a predetermined size.

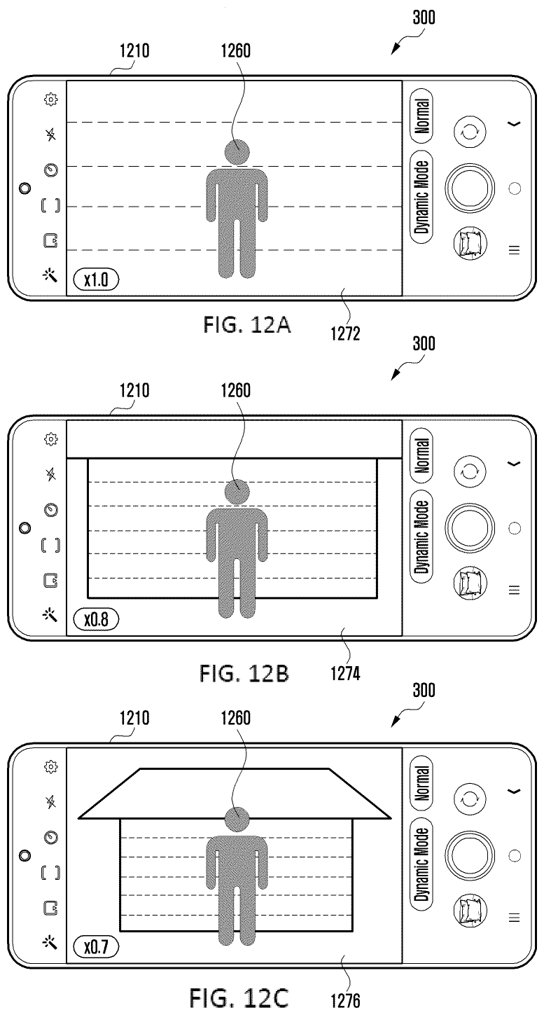

According to an embodiment, the processor 350 may adjust the zoom magnification of the image acquired from the secondary camera according to the determined second zoom magnification, and overlay and display the main subject image at a fixed size. Accordingly, the effect that, in the zoom magnification changing process, the main subject remains the same size as before the zoom magnification change and the background object is zoomed in or out may be provided. The process of changing the preview screen in the automatic zoom mode will be described in more detail with reference to FIGS. 12A to 12C.

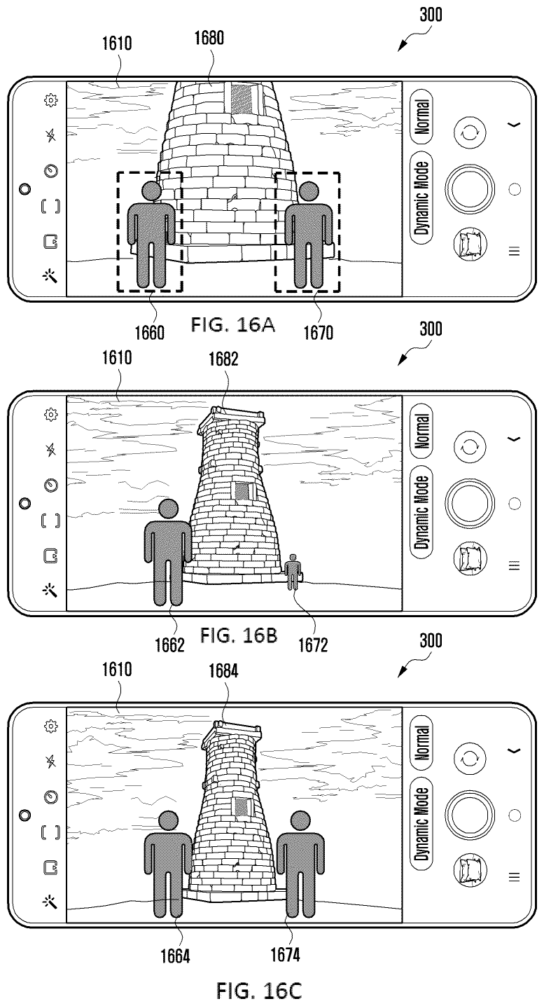

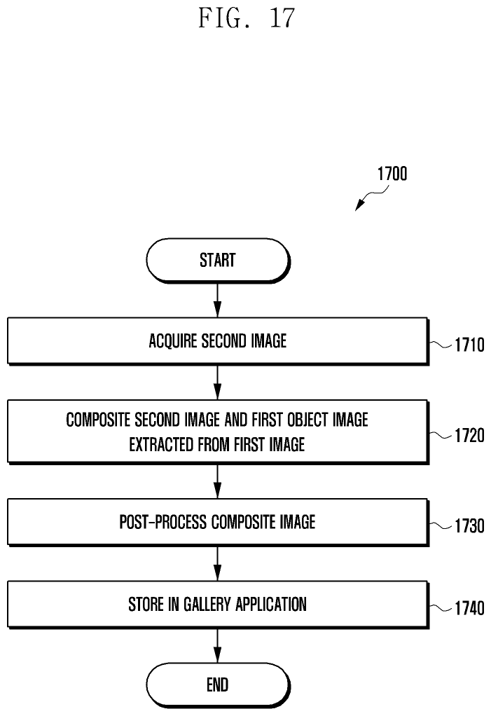

According to an embodiment, the processor 350 may, during the zoom magnification adjustment process, fix the size of at least one object selected based on a user input from among multiple objects included in the first image acquired from the primary camera. For example, when the first image includes two or more persons, at least one of the persons may be selected based on a user input, the selected person may be extracted from the first image (or the first preview image) and maintained at a fixed size, and the unselected person may be zoomed out along with the zoom-out of the second image. An embodiment of selecting multiple objects as the main subject will be described in more detail with reference to FIGS. 16A to 16C.

According to an embodiment, in the automatic zoom mode, when the zoom magnification of the preview image changes based on the determined second zoom magnification, the processor 350 may capture the second image acquired by the secondary camera based on a user input on the photographing button, or may capture the second image immediately after the change to the second zoom magnification without a user input.

According to an embodiment, the electronic device 300 may provide multiple screens that are logically or physically separated. For example, when the electronic device 300 is implemented as a foldable device, the display 330 may include a first region and a second region, separated by a folding axis either horizontally or vertically. In this case, the processor 350 may display a preview image acquired from the first camera 312 or a captured first image in the first region, and may display a preview image (e.g., a second preview image or a third preview image), in which a main subject image is overlaid on a second image, in the second region in real time.

According to an embodiment, the processor 350 may acquire the second image while the third preview image is displayed, and generate a composite image (or a dynamic zoom image) by compositing the second image with the main subject image extracted from the first image. For example, in the composite image, the ratio of the size of a main subject to the size of a background object may be larger compared to the first image, the second image, or the actual photographed scene. According to an embodiment, the processor 350 may perform, in the background, an operation of compositing the main subject image and the second image to generate the composite image while images are captured in a dynamic zoom mode.

According to an embodiment, the processor 350 may store the process of zooming in or out from the second preview image to the third preview image in the memory 320 as video information

According to an embodiment, the processor 350 may composite the main subject image with a background object in the second image by using feature detection and/or feature matching in the first image and/or the second image. For example, the processor 350 may use a feature detection process to find characteristic parts, such as shape, brightness, or color, within the first image and/or the second image. The processor 350 may find common characteristic parts between the two images through a feature matching process. For example, the processor 350 may find each characteristic part in the two images, measure the similarity of each characteristic part, and match the most similar characteristic parts to each other. The processor 350 may use these matched characteristic parts to match a main subject and a background object in the two images having different magnifications, and may position the main subject separated from the first image in a correct location on a composite image (or dynamic zoom image).

According to an embodiment, the processor 350 may use an AI model to perform a feature detection and/or feature matching process for image compositing. For example, the processor 350 may transmit a first image and/or a second image to a server AI model via a communication module and receive the processing result from the server AI model, or may use an on-device AI model executed by the processor 350.

According to an embodiment, when movement of the main subject (e.g., a person) occurs while a second preview image or a third preview image is displayed after acquiring a first image by using a primary camera, the processor 350 may recognize the occurrence of the movement. For example, a person, as a main subject, may move, such as raising a hand, before a second image is captured using a secondary camera. In this case, the raising of the hand may cause interference in the region of the person as the main subject and the region of a building as a background object. That is, the region where the person raises the hand may be a region where the building is displayed in the first image, and a region where the person's hand is displayed in the second image. According to an embodiment, when the movement of the main subject occurs before the acquisition of the second image while the second preview image or the third preview image is displayed, the processor 350 may use an AI model to in-paint or out-paint the interfered part.

According to an embodiment, the processor 350 may continuously or periodically acquire second image information by driving the secondary camera in the background at least partially concurrently while driving the primary camera or during the time of acquisition of first image information using the primary camera. The processor 350 may generate a composite image by compositing at least a portion of the second image information, acquired via background driving, with a main subject image. For example, when the movement of the main subject (e.g., a person) occurs while the second preview image or the third preview image is displayed after acquiring the first image by using the primary camera, causing interference between the main subject and the background object, the processor 350 may generate a composite image by using the second image information that was previously acquired using the secondary camera at or before the time the main subject image was acquired.

In an embodiment, the processor 350 may extract a main subject from the second image captured using the secondary camera, remove a region of the main subject, and use an AI model to in-paint the removed region in consideration of image information of the surrounding region to generate a third image. The processor 350 may notify the user that the third image, in which the main subject has been removed and only a background region remains, has been generated. The processor 350 may display a second preview image by overlaying a preview screen including the generated third image and a main subject image obtained by extracting a main subject from the first image, and may display a third preview image by changing the zoom magnification of the third image.

According to an embodiment, when movement of the main subject occurs in a state in which a photographing command is received during driving of the primary camera and the first image information is acquired, the processor 350 may use a UI to notify the user of a change in the main subject.

According to an embodiment, the processor 350 may, while the preview image acquired through the primary camera is displayed, determine the zoom magnification of the secondary camera related to the background object by using the second image information acquired through the secondary camera in the background, and store the first image acquired through the primary camera in response to a photographing command from the user, and store a composite image (or a dynamic zoom image), in which the main subject image extracted from the first image and the second image acquired through the secondary camera are composited, in the memory 320.

According to an embodiment, after generating the composite image (or the dynamic zoom image), the processor 350 may switch the secondary camera to another camera among the cameras 310 to perform, again, the process of generating a composite image. For example, the processor 350 may select the third camera 316 as a primary camera and the second camera 314 as a secondary camera, and composite a main subject image acquired by the third camera 316 with a background object image acquired by the second camera 314, thereby generating and storing a first composite image. Further, the processor 350 may select the third camera 316 as a primary camera and the first camera 312 as a secondary camera, and composite a main subject image acquired by the third camera 316 with a background object image acquired by the first camera 312, thereby generating and storing a second composite image. For example, when multiple background objects are located in the background of a main subject, the processor 350 may generate a first composite image including a main subject captured by the third camera 316 and a relatively small-sized first background object (e.g., a portion of a building, a natural object, a signboard, or a trademark) captured by the second camera 314, and may generate a second composite image including the main subject captured by the third camera 316 and a relatively large-sized second background object captured by the first camera 312 (e.g., the entire building).

According to an embodiment, the processor 350 may acquire a main subject image by using a primary camera (e.g., the third camera 316), acquire a first background object image by adjusting the zoom magnification of a secondary camera (e.g., the second camera 314) while keeping the size of the main subject image fixed, acquire a second background object image by adjusting the zoom magnification of a tertiary camera (e.g., the first camera 312) while keeping the main subject image and the first background object image fixed, and then composite the main subject image, the first background object image, and the second background object image, which have been captured at different zoom magnifications, to generate a composite image (or a final image).

According to an embodiment, the processor 350 may perform various post-processing processes on the generated composite image (or dynamic zoom image), and then store the composite image in the memory 320. For example, the post-processing processes may include boundary line correction, and/or wide-angle distortion correction. Boundary line correction may include configuring and adjusting the region of a boundary line through a tri-mapping process, and processing the boundary line at a low scale to provide a blur effect, thereby producing a natural result. The processor 350 may perform boundary line correction on the boundary line between the main subject and the background object when compositing the main subject image and the second image. The processor 350 may also correct a distortion, caused by a difference in the refractive indices of a main subject and a background object photographed at different angles of view, to produce a natural result. The processor 350 may perform various other image post-processing operations.

According to an embodiment, the processor 350 may provide composite images (or dynamic zoom images) stored in the memory 320 to a user via a gallery application.

According to an embodiment, the processor 350 may select, via the gallery application, one of the first image, the second image, and the composite image, which have been stored, as a representative photo and provide the selected image as a thumbnail. Based on a user input for the thumbnail, the processor 350 may display at least one of the first image, the second image, and the composite image, and may provide a menu that allows the user to configure options such as archiving, deleting, or editing images.

According to an embodiment, the processor 350 may provide a function of selecting and modifying the magnification of a background object in the gallery application. For example, the processor 350 may store, as video information, image information that is acquired until the secondary camera acquires the second image. For example, the stored video information may include a main subject image having a fixed size and a video in which the zoom magnification changes from the second preview image to the third preview image. When a user adjusts the zoom magnification of a background object on a dynamic zoom image in the gallery application, the processor 350 may, based on the stored video information, acquire a frame corresponding to the zoom magnification adjusted by the user and composite the frame with the main subject image.

According to an embodiment, the composite image may be a still image, or may be a video. For example, when the processor 350 wishes to implement the composite image as a video, the processor 350 may extract a main subject region from first video information acquired using a primary camera, zoom out second video information acquired using a secondary camera, and then composite the second video information with the main subject region to capture a video.

Instructions for performing the operations of the electronic device 300 (or the processor 350) described above may be stored on a computer readable recording medium. The recording medium may be tangible and non-transitory. The recording medium may store one or more computer programs including the instructions.

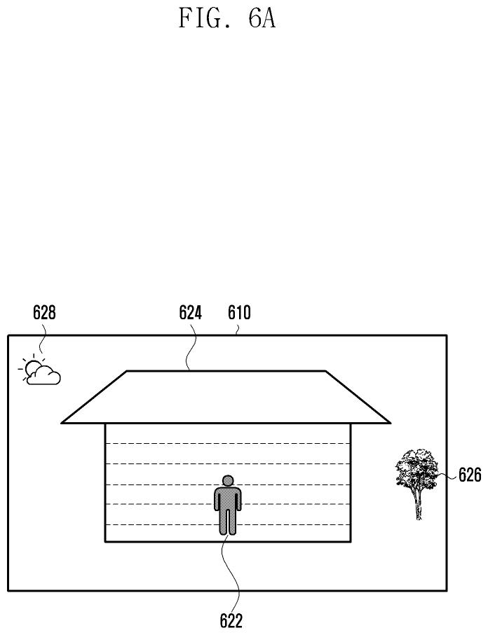

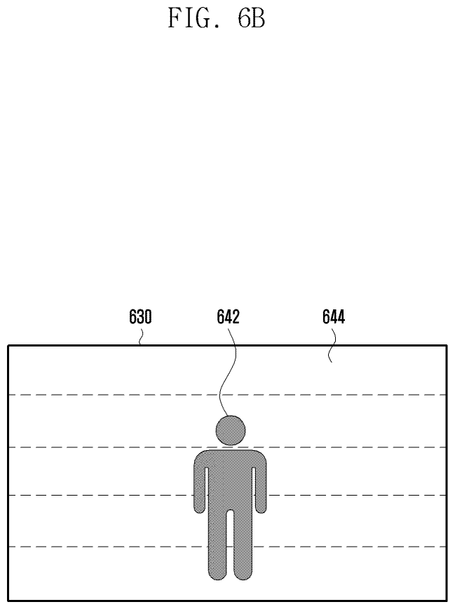

FIGS. 6A and 6B illustrate an image acquired using a first camera and a second camera of an electronic device according to various embodiments of the disclosure.

According to an embodiment, an electronic device (e.g., the electronic device 300 of FIG. 5) may include a first camera (e.g., the first camera 312 of FIG. 3 or the first camera 312 of FIG. 5) and a second camera (e.g., the second camera 314 of FIG. 3 or the second camera 314 of FIG. 5) having different angles of view. For example, the first camera may be an ultra-wide (UW) camera capable of capturing an image with a field of view corresponding to an analog optical zoom magnification of ×0.6, and the second camera may be a wide (W) camera capable of capturing an image with a field of view corresponding to an analog optical zoom magnification of ×1.0.

In an embodiment, the first camera and the second camera may be disposed adjacent to each other so as to capture images substantially in the same direction. Accordingly, a main subject may be included in both the image from the first camera and the image from the second camera, and at least some of objects other than the main subject may be included in the image from the first camera but not in the image from the second camera.

According to an embodiment, an image 610 captured by the first camera may have a relatively wide field of view. Referring to FIG. 6A, the image 610 captured by the first camera may include a person 622 as a main subject, a building 624 as a background object, and may further include other surrounding objects 626 and 628. An image 630 captured by the second camera may have a narrower field of view than the image 610 from the first camera. Referring to FIG. 6B, the image 630 captured by the second camera may include only a person 642 as a main subject and a partial region 644 of a building as a background object.

According to an embodiment, the electronic device may acquire the first image 610 and the second image 630 having different angles of view, and may display a preview image obtained by overlaying the main subject 642, extracted from the second image 630, on the first image 610. When the electronic device may change the zoom magnification in response to a user input, or may automatically change the zoom magnification to a determined zoom magnification (e.g., zoom-in/zoom-out), the zoom magnification of the first image 610 may be changed, but the size of the main subject 642 extracted from the second image 630 may remain fixed.

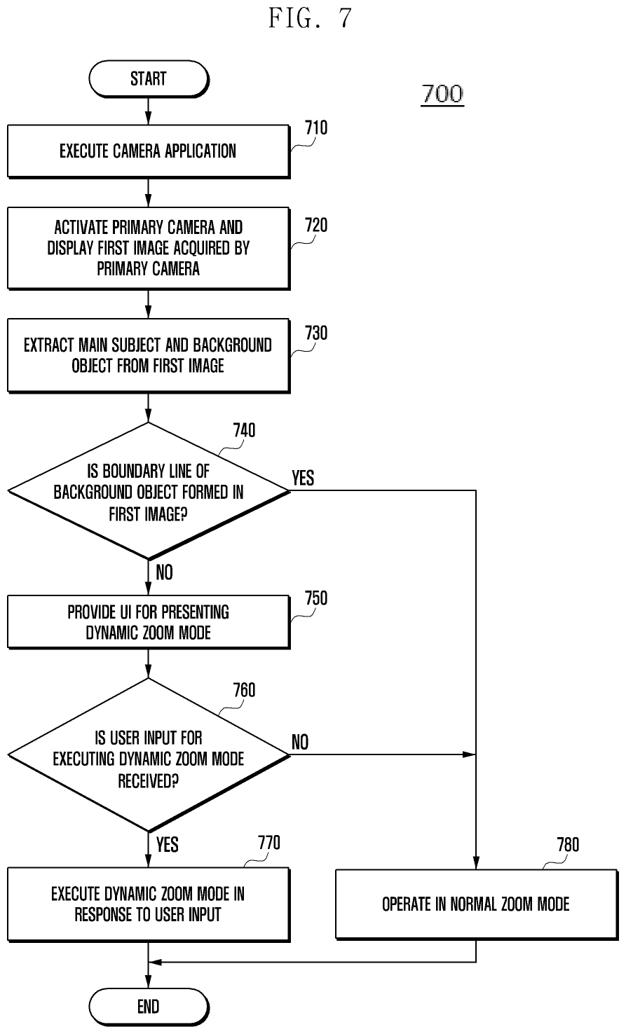

FIG. 7 is a flowchart of a method for executing a dynamic zoom mode by an electronic device according to an embodiment of the disclosure.

According to an embodiment, an illustrated method 700 may be performed by an electronic device (e.g., the electronic device 300 of FIG. 5), and the technical features which have been previously described may be omitted from description below.

Referring to FIG. 7, according to an embodiment, in operation 710, the electronic device may execute a camera application.

According to an embodiment, in operation 720, the electronic device may activate a primary camera and display a first image, acquired by the primary camera, as a first preview image on a display. The first image may include a main subject (e.g., a person) and a portion of a background object (e.g., a building).

According to an embodiment, in operation 730, the electronic device may extract the main subject and background object from the first image. For example, the electronic device may use an object segmentation function to segment the region of each of objects, which include the main subject (or a first object), in the first image.

According to an embodiment, in operation 740, the electronic device may identify whether a boundary line of the background object (or a second object) is formed in the first image. When the first image includes only a portion of the background object, the boundary line of the background object may not be formed in the first image.

According to an embodiment, the electronic device may determine whether to trigger a dynamic zoom mode, based further on the scene of the captured image and/or the type of object included in the image.

According to an embodiment, when the boundary line of the background object is not formed in the first image, the electronic device may provide, in operation 750, a UI for suggesting a dynamic zoom mode. For example, the electronic device may display an item indicating the dynamic zoom mode on the preview image, and/or display an item indicating the dynamic zoom mode via a mode configuration UI.

According to an embodiment, in operation 760, the electronic device may identify whether a user input for executing the dynamic zoom mode is received, and when the user input is received, the electronic device may execute the dynamic zoom mode in response to the user input in operation 770.

According to an embodiment, when the dynamic zoom mode is executed, the electronic device may provide, on the preview image, an item that indicates the execution of the dynamic zoom mode. In an embodiment, even when the dynamic zoom mode is executed, the electronic device may continue to display the preview image, acquired from the activated primary camera, at the same zoom magnification as before the dynamic zoom mode is executed.

According to an embodiment, in operation 780, the electronic device may operate in a normal zoom mode when, as a result of the check in operation 740, the boundary line of the background object is formed in the first image, or when no user input for executing the dynamic zoom mode is not received in operation 760.

According to an embodiment, instructions for performing each of the operations constituting the method may be stored on a tangible non-transitory computer readable recording medium.

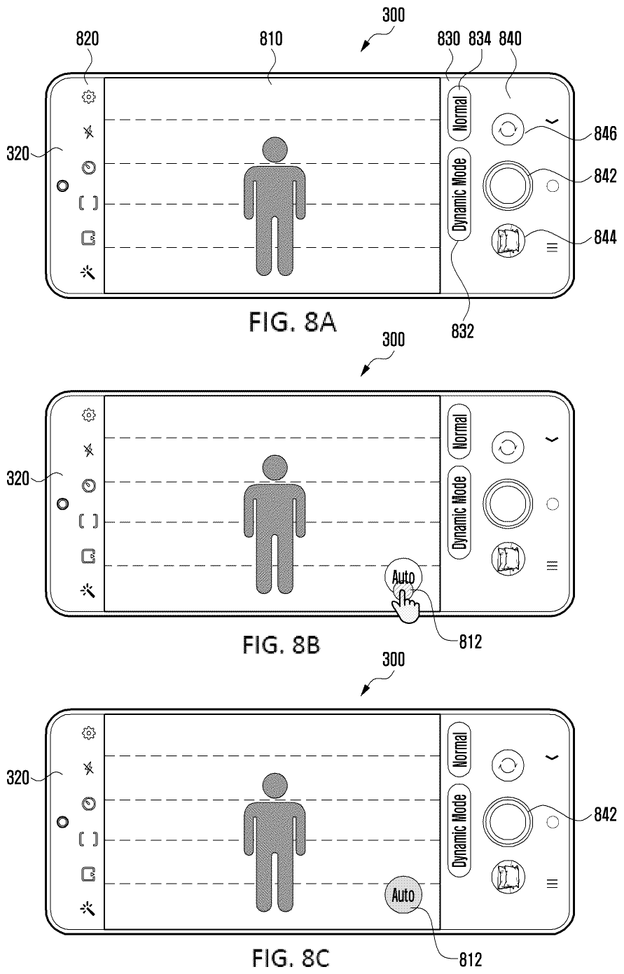

FIGS. 8A, 8B, and 8C illustrate a UI which an electronic device provides when executing a dynamic zoom mode according to various embodiments of the disclosure.

FIG. 8A illustrates a screen provided on a display 330 of an electronic device 300 when a specified condition for triggering a dynamic zoom mode is satisfied.

Referring to FIG. 8A, a camera application screen of the electronic device 300 may include a preview region 810 in which a preview image is displayed, an option menu region 820 that includes menus for configuring various photographing-related options (e.g., filters, motion photo, ratio, timer, and flash), a photographing button region 840 that includes a photographing button 842, a gallery execution button 844, a front/rear camera switch button 846, and a mode configuration region 830 that includes items for selecting a photographing mode.

According to an embodiment, the electronic device 300 may provide an item 832 for executing a dynamic zoom mode when the specified condition for triggering the dynamic zoom mode is satisfied, such as when the entire region of a background object is not formed in a first image, and/or when a boundary line of the background object is not formed in the first image. The electronic device 300 may execute the dynamic zoom mode when a user input on the item 832 is received. Further, when a user input on an item 834 for switching to a normal zoom mode is received during the execution of the dynamic zoom mode, the electronic device 300 may switch back to a normal zoom mode. According to another embodiment, when a user input on an item 832 for executing the dynamic zoom mode is received within the mode configuration region 830, the electronic device 300 may execute the dynamic zoom mode without analyzing information within the image to identify whether the specified condition is satisfied.

According to an embodiment, the electronic device 300 may provide an auto selection item 812 that enables the selection of automatic photographing or manual photographing in the dynamic zoom mode. For example, automatic photographing may be a method wherein, when a photographing command is received while a first preview image is displayed, a second preview image, in which a second image is overlaid with a main subject image extracted from a first image, is displayed, the second image is immediately captured without an additional user input after the zoom magnification is changed, and the second image and the main subject image are composited and stored. Manual photographing may be a method wherein, while the second preview image is displayed, the second image is captured in response to a user input on the photographing button 842 after the zoom magnification is changed, and a composite image (or a dynamic zoom image) is stored. According to an embodiment, the auto selection item 812 may be configured as a button that can be turned on/off by a touch input, and may be displayed in the preview region 810 to overlay the preview image.

Referring to FIG. 8B, when a user input on the auto selection item 812 is received, the electronic device 300 may proceed to automatic photographing and highlight the auto selection item 812 to indicate automatic photographing, as shown in FIG. 8C.

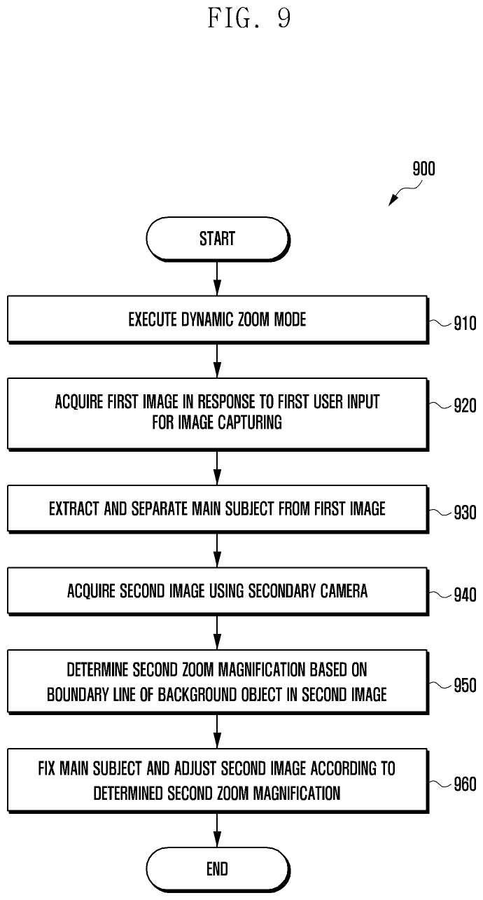

FIG. 9 is a flowchart of a method by which an electronic device composites a main subject and a background object and provides the composite as a preview according to an embodiment of the disclosure.

According to an embodiment, an illustrated method 900 may be performed by an electronic device (e.g., the electronic device 300 of FIG. 5), and the technical features which have been previously described may be omitted from description below.

Referring to FIG. 9, according to an embodiment, in operation 910, the electronic device may execute a dynamic zoom mode. When the dynamic zoom mode is executed, the electronic device may provide an item indicating the dynamic zoom mode via a preview region and/or a mode configuration region of a camera application screen. Even when the dynamic zoom mode is executed, the electronic device may continue to display an image acquired by a previously activated primary camera at the same zoom magnification (e.g., a first zoom magnification) as before.

According to an embodiment, in operation 920, the electronic device may receive a first user input for capturing an image and acquire a first image. For example, the electronic device may receive a first user input on a photographing button while a first preview image is displayed. The electronic device may acquire a first image having a first zoom magnification in response to the first user input.

According to an embodiment, in operation 930, the electronic device may extract and separate a main subject (or a first object) (e.g., a person) from the first image. The first image may include the main subject and a portion of a background object positioned behind the main subject, and the electronic device may separate the main subject by using an object segmentation function in the first image. The electronic device may store the extracted and separated region of the main subject as a main subject image (or a first object image).

According to an embodiment, in operation 940, the electronic device may acquire a second image by using a secondary camera.

According to an embodiment, the electronic device may select, as the secondary camera, a camera among the cameras that is capable of including the entire region of the background object in the image. For example, when the primary camera is a second camera (or a W camera) having a relatively narrow field of view, the electronic device may select a first camera (or a UW camera) having a relatively wide field of view as the secondary camera. According to an embodiment, the electronic device may select, as the secondary camera, a camera among the cameras that is capable of acquiring image information of the background object in accordance with reference composition and/or aspect ratio.

In an embodiment, when no camera capable of capturing the entire region of the background object in an image is present among the cameras, the electronic device may provide, via a display, a movement guide UI that guides a user of the electronic device to move. When the user of the electronic device moves according to the movement guide UI, a specific camera may capture the entire region of the background object, and that camera may be selected as the secondary camera.

In an embodiment, the electronic device may display a second preview image in which the main subject image (or first object image) is overlaid on a second image. When switching from the first preview image to the second preview image, the electronic device may maintain the zoom magnification at the same zoom magnification (e.g., the first zoom magnification) as that of the first preview image. Accordingly, when switching to the second preview image, the user may not experience a sense of disparity, and the main subject may be displayed at substantially the same size.

According to an embodiment, in operation 950, the electronic device may determine the zoom magnification based on a boundary line of a background object in the second image. According to an embodiment, the electronic device may determine that the zoom magnification (or a maximum zoom magnification), at which the entire region of the background object included in the second image can be displayed, is a second zoom magnification. For example, at the first zoom magnification, only a portion of the background object may be included in the second preview image, and the electronic device may gradually decrease the zoom magnification from the first zoom magnification to identify a zoom magnification at which the boundary line of the background object can be formed in the preview image. According to an embodiment, the second zoom magnification may be determined by a binary search using the first zoom magnification and the optical zoom magnification of the secondary camera.

According to an embodiment, when configured to a manual zoom mode, the electronic device may provide a zoom configuration UI for configuring the zoom magnification at least partially concurrently with displaying the second preview image, and may determine the second zoom magnification based on a user input on the zoom configuration UI.

According to an embodiment, in operation 960, the electronic device may fix the main subject and adjust the zoom magnification of the second image, based on the determined zoom magnification. Thus, the effect that, in the zoom magnification change process, the main subject remains the same size while the background object is zoomed out may be provided.

According to an embodiment, after the zoom magnification of the second image is changed, the electronic device may capture the second image either automatically or based on a photographing command from the user.

According to an embodiment, instructions for performing each of the operations including the method 900 may be stored on a tangible non-transitory computer-readable recording medium.

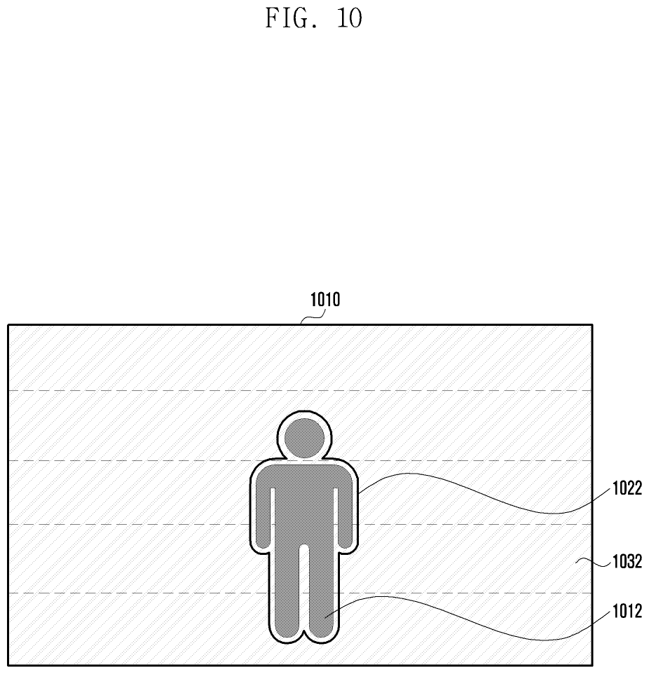

FIG. 10 illustrates a process of extracting a main subject from a first image by an electronic device according to an embodiment of the disclosure.

According to an embodiment, an electronic device (e.g., the electronic device 300 of FIG. 5) may display, on the display, a first preview image that includes a first image 1010 acquired by a camera (e.g., a primary camera) among cameras (e.g., the first camera 312, the second camera 314, and the third camera 316 of FIG. 5) while a dynamic zoom mode is executed. Referring to FIG. 10, the first image 1010 may include a person 1012 as a main subject and a partial region 1032 of a building as a background object.

According to an embodiment, the electronic device may acquire the first image 1010 in response to a first user input while the first preview image is displayed.

According to an embodiment, the electronic device may extract the main subject (or first object) included in the acquired first image 1010. According to an embodiment, the electronic device may separate the main subject (e.g., a person) 1012 from the first image 1010 by using an object segmentation function. The electronic device may identify objects included in the first image and identify the region 1022 of the main subject among the identified objects. For example, the electronic device may identify the objects included in the image by using various object detection algorithms based on deep learning, such as region-based convolutional neural networks (R-CNNs), you only look once (YOLO), and single-shot multibox detector (SSD).

According to an embodiment, the electronic device may highlight and display the region 1022 of the extracted main subject.

According to an embodiment, the electronic device may temporarily store a main subject image generated from the first image 1010 in memory.

Referring to FIG. 10, the electronic device may extract the region 1022 of the person, which is the main subject, from the first image 1010 and store the region 1022 as a main subject image (or a first object image).

FIG. 11 illustrates a process in which an electronic device determines a zoom magnification corresponding to the boundary of a background object according to an embodiment of the disclosure.

Referring to FIG. 11, when a second camera (e.g., the second camera 314 of FIG. 5) is used as a primary camera to acquire a first image, the electronic device may select a first camera (e.g., the first camera 312 of FIG. 5) as a secondary camera to acquire a second image 1110. The first camera may have a wider field of view than the second camera.

According to an embodiment, the electronic device may determine a second zoom magnification to be applied to the second image 1110, based on a background object included in the second image 1110 captured by the secondary camera. According to an embodiment, the electronic device may determine the second zoom magnification as the zoom magnification (or maximum zoom magnification) at which the entire region of the background object included in the second image 1110 can be displayed. For example, at a first zoom magnification, only a portion of the background object may be included in a second preview image, and the electronic device may gradually decrease the zoom magnification from the first zoom magnification to identify a zoom magnification at which the boundary line of the background object can be formed in the preview image.

According to an embodiment, depending on the zoom magnification, the boundary line of the background object may or may not be included in the image (or preview image). For example, in the case of an image captured by zooming in at a relatively high magnification (e.g., ×1.0 or ×0.8), due to the relatively narrow field of view, the boundary line of a background object is formed outside the field of view of the image, and thus may not be formed in the image. In this case, when the electronic device zooms out to a lower zoom magnification (e.g., ×0.7), the field of view becomes larger and the boundary line of the background object may be included in the image.

According to an embodiment, the electronic device may determine the second zoom magnification by using a binary search. A binary search is an algorithm for quickly finding a specific value in a sorted array, wherein a target value may be found by dividing the array in half to narrow the search range. The electronic device may determine the second zoom magnification by a binary search using the first zoom magnification of a first preview image and the optical zoom magnification of the second camera.

According to an embodiment, when the user captures the second image 1110 while the first zoom magnification of the first preview image is ×1.0, the electronic device may identify the maximum zoom magnification, at which the boundary line of the background object can be formed in the preview image, by a binary search using ×0.6, which is the optical zoom magnification of the first camera determined as the secondary camera, and ×1.0, which is the first zoom magnification.

Referring to FIG. 11, the electronic device may crop the second image 1110 into an image 1122 having a zoom magnification of ×1.0 and display the image 1122 as the second preview image. The electronic device may crop an image 1124 to a size corresponding to ×0.8, which is an intermediate value between ×0.6 and ×1.0, and then identify whether the boundary line of the background object is formed in the image 1124 of ×0.8. When the boundary line of the background object is not formed in the image 1124 of ×0.8, the electronic device may crop an image 1126 to a size corresponding to ×0.7, which is an intermediate value between ×0.6 and ×0.8, and identify whether the boundary line of the background object is formed in the image 1126 of ×0.7.

According to an embodiment, when a zoom magnification at which the boundary line of the background object is formed is identified during the binary search, the electronic device may identify whether the boundary line of the background object is formed in an image having an intermediate value between the identified zoom magnification and a larger zoom magnification, and, through this process, identify the maximum zoom magnification at which the boundary line of the background object is formed.

According to the embodiment of FIG. 11, the image 1126 of ×0.7 includes the entire region of the background object, and the image 1124 at ×0.8 does not include the entire region of the background object, in which case the electronic device may determine ×0.7 to be the second zoom magnification.

FIGS. 12A, 12B, and 12C illustrate a process in which an electronic device changes a zoom magnification according to various embodiments of the disclosure.

According to an embodiment, when a second zoom magnification is determined, an electronic device 300 may change the zoom magnification of a second image to the second zoom magnification, and display, on a display 1210, a third preview image obtained by overlaying the second image having the second zoom magnification with a main subject image 1260 (or a first object image).

According to an embodiment, when a first image having a first zoom magnification is captured in a dynamic zoom mode, the electronic device 300 may crop the second image acquired by a first camera determined as a secondary camera to the first zoom magnification, and display on the display 1210, a second preview image obtained by overlaying the cropped image with the main subject image 1260 extracted from the first image.

Referring to FIG. 12A, the first zoom magnification may be ×1.0, and the electronic device 300 may display a second preview image 1272 obtained by overlaying the second image cropped to ×1.0 with the main subject image 1260 extracted from the first image. The zoom magnification of the second preview image 1272 may be the same as the zoom magnification of a previously displayed first preview image, thereby providing continuity of the preview images.

According to an embodiment, the electronic device 300 may change the zoom magnification of the second image to the second zoom magnification based on the determined second zoom magnification. The electronic device 300 may display, on the display 1210, the third preview image obtained by overlaying the second image having the second zoom magnification with the main subject image 1260. For example, the second zoom magnification may be ×0.7, and the electronic device 300 may zoom out the second image from the first zoom magnification of ×1.0 to ×0.7. In this case, the size of the main subject image 1260 may be fixed.

Referring to FIG. 12B, the size of the main subject 1260 may be fixed while a background object (e.g., a building) in the second image is zoomed out, thereby allowing a larger region of the background object to be provided as a preview image 1274.

Referring to FIG. 12C, state in which the second image is zoomed out to the second zoom magnification is illustrated, wherein the entire region of the background object may be provided as a preview image 1276 while the size of the main subject 1260 is fixed. In this way, in the process of switching in the order of FIGS. 12A, 12B, and 12C, the main subject may remain the same size, and the background object may be zoomed out.

FIGS. 13A and 13B illustrate a process in which an electronic device changes a zoom magnification according to various embodiments of the disclosure.

According to an embodiment, when a dynamic zoom mode is configured to a manual zoom mode, an electronic device 300 may provide, via a display 1310, a zoom configuration UI 1320 that allows a zoom magnification to be configured at least partially concurrently with displaying a second preview image. For example, the zoom configuration UI 1320 may be provided as selectable items corresponding to multiple zoom magnifications (e.g., ×0.6, ×1.0, and ×3.0), may be provided in the form of a scrollable bar from which a specific zoom magnification can be selected, and/or may be provided such that the zoom magnification is adjustable in response to multi-touch interaction (e.g., pinch to zoom) by a user.

Referring to FIG. 13A, the zoom configuration UI 1320 may be provided in the form of a bar scrollable in multiple zoom magnification ranges, and the zoom magnification may be changed based on a user's touch & drag. The zoom configuration UI 1320 may be displayed to overlay a preview image 1372.

According to an embodiment, the electronic device 300 may adjust the zoom magnification of the image acquired from the secondary camera based on user input, and display the main subject image 1360 overlaid at a fixed size.

Referring to FIG. 13B, if the zoom magnification is changed to ×0.6 in response to user input to the zoom configuration UI 1320, the second image including the background objects on the preview image 1374 may be zoomed out, but the main subject may be fixed at a size equal to the zoom magnification of ×1.0. If the user presses the photographing button 1342 after making this zoom magnification change, the electronic device 300 may take the second image based on the currently displayed preview image 1374, and may composite and store the second image with the main subject image (or first object image) 1360.

FIGS. 14A and 14B illustrate a process of acquiring a composite image in an automatic zoom mode and a manual zoom mode according to various embodiments of the disclosure.

According to an embodiment, an electronic device 300 may provide an auto selection item 1412 that enables the selection of automatic photographing or manual photographing in a dynamic zoom mode. For example, automatic photographing may be a method wherein, when a photographing command is received while a first preview image is displayed, a second preview image, in which a second image is overlayed with a main subject image extracted from a first image, is displayed, the second image is immediately captured without an additional user input after the zoom magnification is changed, and the second image and the main subject image are composited and stored. Manual photographing may be a method wherein, while the second preview image is displayed, the second image is acquired in response to a user input on a photographing button 1442 after the zoom magnification is changed, and a composite image is stored. According to an embodiment, the auto selection item 1412 may be configured as a toggle button that can be turned on/off by touch input, and may be displayed in a preview region to overlay the preview image.

Referring to FIG. 14A, the electronic device 300 may display a third preview image 1410, in which a main subject image extracted from a first image is overlaid on a second image having a second zoom magnification, on the preview region. For example, when a photographing command is received while a first preview image is displayed, the electronic device 300 may display a second preview image in which the main subject image extracted from the first image is overlaid on the second image having a first zoom magnification, and may display the third preview image by adjusting the zoom magnification of the second image to the second zoom magnification while keeping the main subject image fixed.

When automatic photographing is selected, referring to FIG. 14A, the electronic device 300 may immediately capture the second image without an additional input from the user after the zoom magnification of the second image is changed from the second preview image having the first zoom magnification to the third preview image 1410having the second zoom magnification. The electronic device 300 may composite the captured second image with the main subject image and store a composite image.

When manual photographing is selected, referring to FIG. 14B, the electronic device 300 may, after change to the third preview image 1410, capture the second image in response to a user input on the photographing button 1442 and store a composite image.

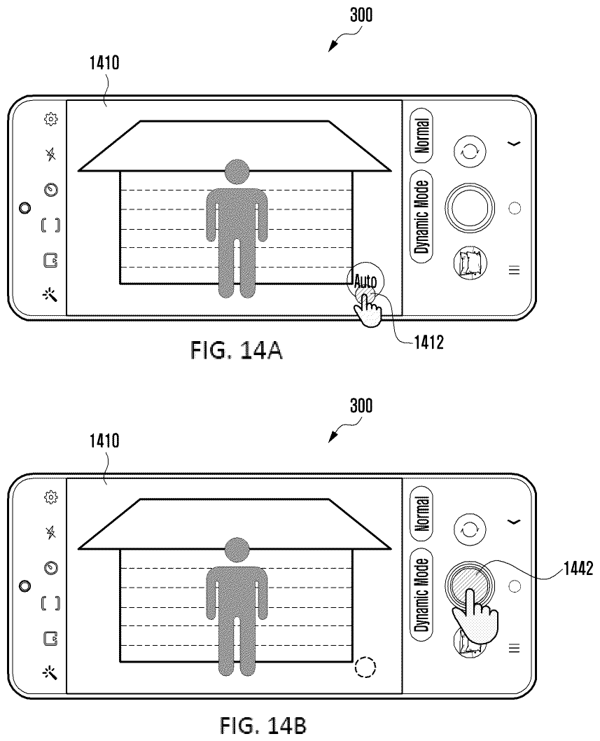

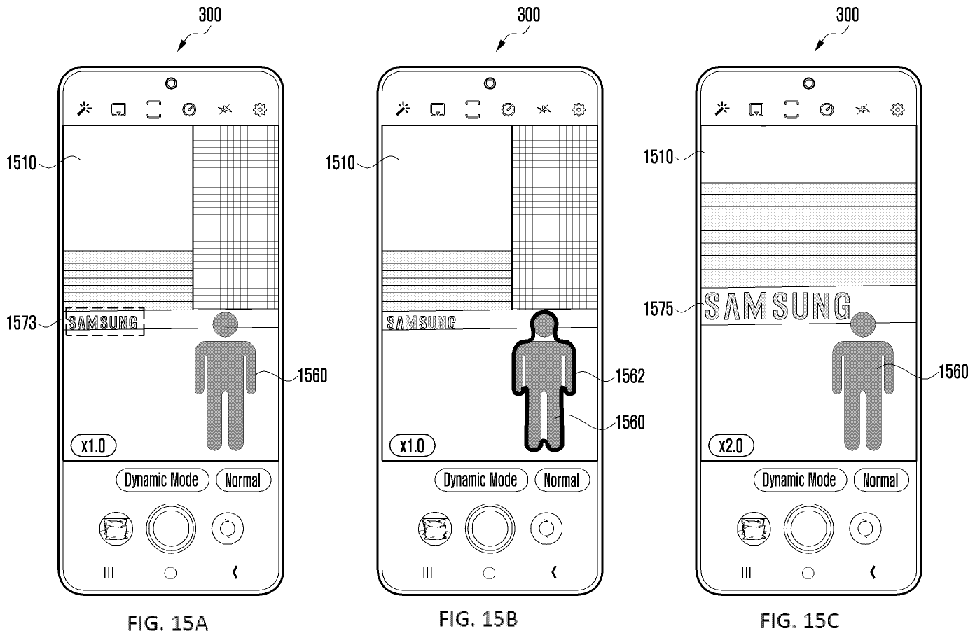

FIGS. 15A, 15B, and 15C illustrate a process in which an electronic device changes a zoom magnification according to various embodiments of the disclosure.

According to an embodiment, an electronic device 300 may determine, based on a background object included in a second image captured by a secondary camera, a second zoom magnification to be applied to the second image. The electronic device 300 may determine the second zoom magnification as the zoom magnification (or a maximum zoom magnification) at which the entire region of the background object included in the second image can be displayed or at which the boundary line of the background object can be included.

According to an embodiment, the electronic device 300 may determine the second zoom magnification in consideration of the size and location of a main subject, the distance between the main subject and the background object, or features of the background object. For example, when the background object includes text or a characteristic shape, the electronic device 300 may determine the second zoom magnification as the zoom magnification at which the text or the shape can have at least a predetermined size.

Referring to FIG. 15A, a first image acquired via a primary camera may include a person 1560 as a main subject and text 1573 as a background object. The electronic device 300 may display a first preview image including the first image on a display 1510.

Referring to FIG. 15B, the electronic device 300 may extract the main subject 1560 included in the first image to generate a main subject image.

Referring to FIG. 15C, the electronic device 300 may zoom in a second image to a second zoom magnification in which the size of text 1575 as a background object corresponds to a maximum size where the text is not obscured by the main subject 1560. In this case, the size of the main subject 1560 may be fixed. The electronic device 300 may acquire the second image in an automatic or manual photographing mode, and may composite and store the second image and the main subject image.

FIGS. 16A, 16B, and 16C illustrate a process in which an electronic device changes a zoom magnification according to various embodiments of the disclosure.

According to an embodiment, an electronic device 300 may extract at least one object selected based on a user input from multiple objects included in a first image acquired via a primary camera.

Referring to FIG. 16A, the first image may include a first person 1660, a second person 1670, and a sculpture that is a background object. The electronic device 300 may provide a graphic effect indicating that the first person 1660 and the second person 1670 are selectable, and may select the first person 1660 and/or the second person 1670 as a main subject in response to a user's touch input.

Referring to FIG. 16B, when a first person 1662 is selected in response to the user input, the electronic device 300 may extract the first person 1662, selected as a main subject, from the first image to generate a main subject image. The electronic device 300 may composite the main subject image during the zoom-out of a second image and display the composite as a third preview image. An unselected second person 1672 is not recognized as the main subject, and therefore, may zoom out along with the sculpture as the background object during the zoom-out of the second image. According to another embodiment, the electronic device may remove the unselected second person 1672 from the image. In this case, the electronic device may fill in, via in-painting using an AI model, a region from which the second person 1672 is removed.

According to an embodiment, the electronic device 300 may, through image analysis, select at least one object to be included in the main subject image. For example, the electronic device 300 may analyze an image of at least a partial region (e.g., a facial region) of the first person 1660 and/or the second person 1670, and when the first person 1660 and/or the second person 1670 is recognized as a person (e.g., a family member or a friend) related to a user of the electronic device 300, may determine the first person 1660 and/or the second person 1670 as an object to be included in the main subject image. In this case, the electronic device 300 may use images pre-stored in a gallery application to determine whether the first person 1660 and/or second person 1670 is a person related to the user.

Referring to FIG. 16C, when a first person 1664 and a second person 1674 are selected based on a user input, the electronic device 300 may extract, from the first image, the first person 1664 and the second person 1674 selected as main subjects to generate main subject images. The electronic device 300 may composite the main subject images including the first person 1664 and the second person 1674 during the zoom-out of the second image and display the composite as a third preview image, wherein the first person 1664 and the second person 1674 may be displayed at a fixed size even during zooming out.

FIG. 17 is a flowchart of a method for compositing and storing images of a main subject and a background object by an electronic device according to an embodiment of the disclosure.

According to an embodiment, an illustrated method 1700 may be performed by an electronic device (e.g., the electronic device 300 of FIG. 5), the technical features which have been previously described may be omitted from description below.

Referring to FIG. 17, according to an embodiment, in operation 1710, the electronic device may acquire a second image captured by a secondary camera. According to an embodiment, in a state in which a third preview image, obtained by overlaying a main subject image on the second image having the zoom magnification changed from a first zoom magnification to a second zoom magnification, is displayed, the electronic device may capture the second image based on a photographing command from a user or in response to the zoom magnification of the second image changing from the first zoom magnification to the second zoom magnification.

According to an embodiment, in operation 1720, the electronic device may composite the second image and a first object image (or the main subject image) extracted from a first image. The second image may have a wider field of view than the first image, and the first object image extracted from the first image may have a larger size than a first object included in the second image.

According to an embodiment, the electronic device may composite the first object image with a background object in the second image by using feature detection and feature matching in the first image and the second image. The electronic device may use the feature detection process to detect characteristic parts, such as shape, brightness, and color, within the first image and the second image and to map the characteristic parts to coordinates. A processor may use the feature matching process to identify common feature points found between the two images and match the identified feature points. For example, the electronic device may find a characteristic part in each of the two images, measure the similarity of each characteristic part, and match the most similar characteristic parts to each other. The processor may use the matched characteristic parts to match a main subject and the background object in the two images having different magnifications, and may position the main subject separated from the first image in a correct location on the composite image.

According to an embodiment, in operation 1730, the electronic device may perform a post-processing operation on the composite image. For example, the post-processing may include boundary line correction, and/or wide-angle distortion correction. The boundary line correction may include configuring and adjusting a region of a boundary line through a tri-mapping process, and processing the boundary line at a low scale to provide a blur effect, thereby producing a natural result. The electronic device may perform boundary line correction on a boundary line between the main subject and the background object when compositing the first object image and the second image. Further, the electronic device may correct a distortion, caused by a difference in refractive indices of the main subject and the background object photographed at different angles of view, to produce a natural result.

According to an embodiment, when interference occurs between the first image and the second image in the main subject region due to movement of the main subject between the capturing of the first image and the capturing of the second image, the electronic device may fill in image information of the region, in which the interference occurred, by using in-painting technology using an AI model.

According to an embodiment, in operation 1740, the electronic device may store the post-processed image in a gallery application.

According to an embodiment, instructions for performing each of the operations constituting the method 1700 may be stored on a tangible non-transitory computer readable recording medium.

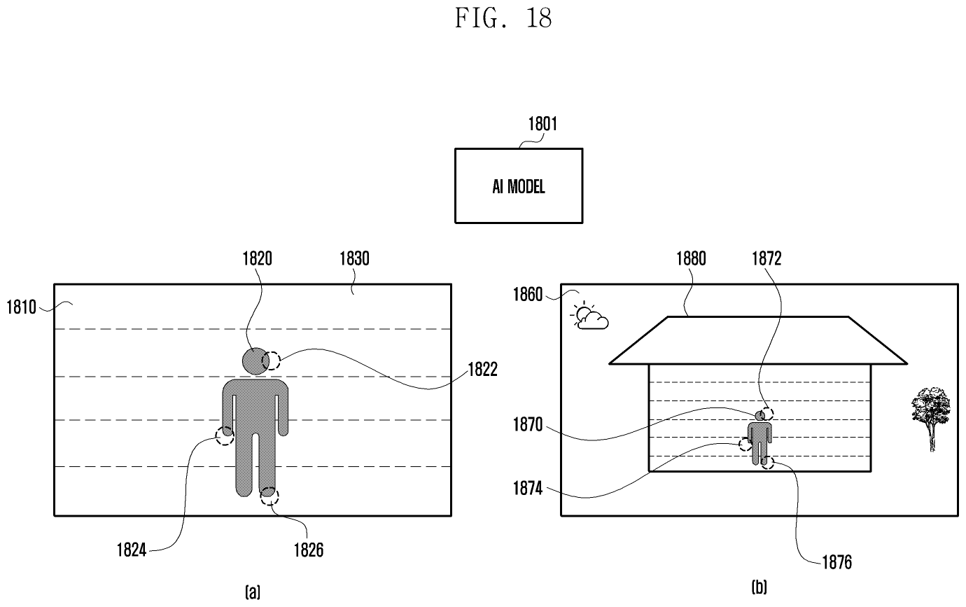

FIGS. 18A and 18B illustrate a process in which an electronic device matches feature points in a first image and a second image according to various embodiments of the disclosure.

According to an embodiment, in a first image 1810 and a second image 1860, the electronic device may composite a first object image with a background object in the second image 1860 by using feature detection and feature matching.

Referring to FIG. 18A, the first image 1810 may be an image captured with a narrow field of view and include a main subject 1820 and a partial region 1830 of a background object, and the second image 1860 may be an image captured with a wide field of view and include a main subject 1870 and the entire region 1880 of a background object.

According to an embodiment, the electronic device may analyze the pixel data of the first image 1810 and the second image 1860 to detect characteristic parts such as shape, brightness, and color and map the characteristic parts to coordinates. For example, the electronic device may recognize the main subjects 1820 and 1870 in the first image 1810 and the second image 1860, respectively, and may recognize characteristic regions 1822, 1824, 1826, 1872, 1874, and 1876, such as corners, edges, and blobs of the main subjects. The electronic device may determine coordinates of the feature points 1822, 1824, 1826, 1872, 1874, and 1876 recognized in the first image 1810 and the second image 1860.

According to an embodiment, the electronic device may identify common feature points found between the first image 1810 and the second image 1860, and match the identified feature points. For example, the feature points in FIG. 18A may be recognized on the boundary line of the main subject (e.g., edges, corners), and may be matched with the feature points in FIG. 18B, respectively.

According to an embodiment, these matched characteristic parts may be used to match the main subject and a background object in the two images having different magnifications, and the main subject separated from the first image 1810 may be positioned in a correct location on a composite image.

According to an embodiment, the process of compositing the main subject image and the second image 1860 may be performed by an AI model 1801. For example, the processor may, via a communication module, transmit the first image 1810 and the second image 1860 to the server AI model 1801 and receive processing results from the server AI model 1801, or alternatively, an on-device AI model 1801 executed by the processor may be used.

According to an embodiment, the AI model 1801 may include a machine learning model trained to determine the composition of a subsequent recommended photo based on a history of capturing, storing, deleting, and/or sharing photos on the electronic device. For example, the machine learning model may be trained or taught to associate a specific type of photo with a specific composition through sufficiently large training data on usage history of a camera and/or a gallery application, photo sharing history, photo sharing target, etc. According to an embodiment, the AI model 1801 may include various transformer models. The operation of the AI model 1801 may include a learning and inference process of finding patterns in data, storing the patterns as generalized regular models, and feeding new data as input to the trained model to acquire results.

According to an embodiment, a user's inputs (e.g., functions performed repeatedly in a consistent sequence) in the electronic device may be monitored to train the AI model 1801. The electronic device (e.g., an application/framework module or a data platform module of the electronic device) may provide the AI model 1801 with information on which subject the user photographed, the composition in which a subject was photographed, which of the cameras was selected for a subject, which photographing options (e.g., brightness, focus, motion photo) were selected, which photos were stored, which photos were shared, how a photo was corrected, which photos were deleted, or which photos were taken at which location. Functions and image information that the user has used in relation to a photo may be input values for training, and the results of using the functions may correspond to a target output.

According an embodiment, the AI model 1801 may learn usage patterns in various devices connected to the user account. The training of the AI model 1801 performed via the electronic device may correspond to initial training, or may correspond to retraining. The training process of the AI model 1801 may include forward propagation and backward propagation. An algorithm such as regression, decision tree, neural network, or k-nearest neighbor may be used for the training, and multiple different machine learning models may be used for each targeted task.

According to an embodiment, the AI model 1801 may include a large language model (LLM). The neural network of the AI model 1801 may include not only the language model, but also various foundation models, such as code models and image models, and/or other artificial intelligence neural network models.

An electronic device according to various embodiments herein may include a display, a first camera having a first field of view, a second camera having a second field of view different from the first field of view, at least one processor, and memory.

According to an embodiment, the memory may store instructions which are executable by the at least one processor and, when executed, cause the electronic device to: display, on the display, a first preview image including a first image having a first zoom magnification and acquired using the first camera; and generate a first object image by extracting a first object included in the first image in response to a first user input while the first preview image is displayed.

According to an embodiment, the memory may store instructions which cause the electronic device to display, on the display, a second preview image obtained by overlaying the first object image on a second image having the first zoom magnification and acquired using the second camera.

According to an embodiment, the memory may store instructions which cause the electronic device to change the zoom magnification of the second image to a second zoom magnification, and to display, on the display, a third preview image obtained by overlaying the first object image on the second image having the second zoom magnification.

According to an embodiment, the memory may store instructions which cause the electronic device to store a composite image corresponding to the displayed third preview image.

According to an embodiment, the first camera and the second camera are disposed in substantially the same direction, and the second field of view may be larger than the first field of view.

According to an embodiment, the first image may include the first object and a portion of a second object positioned behind the first object, and the second image may include the first object and the entire region of the second object.

According to an embodiment, the memory may store instructions which cause the electronic device to determine the second zoom magnification, based on a boundary line of the second object included in the second image.

According to an embodiment, the memory may store instructions which cause the electronic device to determine the second zoom magnification as a zoom magnification at which the entire region of the second object included in the second image is displayed.

According to an embodiment, the memory may store instructions which cause the electronic device to determine the second zoom magnification of the second image by a binary search using the first zoom magnification and an optical zoom magnification of the first camera.

According to an embodiment, the memory may store instructions which cause the electronic device to store the composite image in response to the zoom magnification of the second image changing from the first zoom magnification to the second zoom magnification.

According to an embodiment, the memory may store instructions which cause the electronic device to provide, via the display, a zoom configuration UI for configuring a zoom magnification at least partially concurrently with displaying the second preview image, and to change the zoom magnification of the second image to the second zoom magnification, while maintaining the size of the first object image, based on a third user input on the zoom configuration UI.

According to an embodiment, the memory may store instructions which cause the electronic device to store the composite image, based on a fourth user input which is input while the third preview image is displayed.

According to an embodiment, the memory may store instructions which cause the electronic device to display a mode configuration UI, configured to guide execution of a dynamic zoom mode, on the display when the first image includes the first object and a partial region of a second object positioned behind the first object, and to perform, when the dynamic zoom mode is executed based on a fourth user input on the mode configuration UI, an operation of generating the first object image, an operation of displaying the second preview image, and an operation of displaying the third preview image.

According to an embodiment, the memory may store instructions which cause the electronic device to further overlay and display a third object image, generated by extracting a third object from the first image, on the second preview image and the third preview image when the first object and the third object are selected from multiple objects included in the first image, based on a fifth user input.

An electronic device according to various embodiments herein may include a display, a first camera, a second camera having a field of view different from that of the first camera, at least one processor, and memory.

According to an embodiment, the memory may store instructions which are executable by the at least one processor and, when executed, cause the electronic device to: display, on the display, a first preview image including a first image that is acquired using the first camera; generate a first object image associated with a first object among the first object and a second object included in the first preview image; display, on the display, a second preview image including the first object image and a second image acquired using the second camera, the second image including the second object; adjust and display the second image on the second preview image according to a selected magnification; and store a third image corresponding to the second preview image.

According to an embodiment, the second image may further include the first object, and the first object image included in the second preview image may be at least partially overlayed and displayed on the first object included in the second preview image.

According to an embodiment, the memory may store instructions which cause the electronic device to switch to a photographing mode in which the second preview image is provided, based on a determination that only a portion of the second object is displayable on the first preview image, and to display the second preview image when a photographing command is received in the switched photographing mode.

According to an embodiment, the memory may store instructions which cause the electronic device to display, on the display, a user interface configured to guide movement of a position of the electronic device so that the entire second object is displayable on the second preview image.

According to an embodiment, the magnification may be automatically selected by the electronic device such that at least the entire second object is displayed in the second preview image.

According to an embodiment, the memory may store instructions which cause the electronic device to, while the first preview image is displayed, acquire a second object image representing the second object by using the second camera, and generate the third image by using a portion of the second object image.

According to an embodiment, the first preview image and the second preview image include a third object, and when an input for specifying that the first object is to be generated as the first object image is received from a user, the third object may be removed from the third image by an artificial intelligence model and a position of the third object may be in-painted with other image information.

A method of capturing an image by an electronic device, according to various embodiments herein, may include: displaying a first preview image including a first image having a first zoom magnification and acquired using a first camera; generating a first object image by extracting a first object included in the first image in response to a first user input while the first preview image is displayed; displaying a second preview image obtained by overlaying the first object image on a second image having the first zoom magnification and acquired using a second camera having a field of view different from that of the first camera; changing the zoom magnification of the second image to a second zoom magnification, and displaying a third preview image obtained by overlaying the first object image on the second image having the second zoom magnification; and storing a composite image corresponding to the displayed third preview image.

A computer-readable non-transitory recording medium, according to various embodiments herein, may store instructions for: displaying a first preview image including a first image having a first zoom magnification and acquired using a first camera; generating a first object image by extracting a first object included in the first image in response to a first user input while the first preview image is displayed; displaying a second preview image by overlaying the first object image on a second image having the first zoom magnification and acquired using a second camera having a field of view different from that of the first camera; changing the zoom magnification of the second image to a second zoom magnification, and displaying a third preview image obtained by overlaying the first object image on the second image having the second zoom magnification; and storing a composite image corresponding to the displayed third preview image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a first camera having a first field of view;
a second camera having a second field of view different from the first field of view;
memory storing one or more computer programs; and
one or more processors communicatively coupled to the display, the first camera, the second camera and the memory,
wherein the one or more computer programs include computer-executable instructions that, when executed by the one or more processors individually or collectively, cause the electronic device to:
display, on the display, a first preview image comprising a first image having a first zoom magnification and acquired using the first camera,
generate a first object image by extracting a first object included in the first image in response to a first user input while the first preview image is displayed,
display, on the display, a second preview image obtained by overlaying the first object image on a second image having the first zoom magnification and acquired using the second camera,
change the zoom magnification of the second image to a second zoom magnification, and display, on the display, a third preview image obtained by overlaying the first object image on the second image having the second zoom magnification, and
store a composite image corresponding to the displayed third preview image.

2. The electronic device of claim 1,
wherein the first camera and the second camera are disposed in substantially the same direction, and
wherein the second field of view is larger than the first field of view.

3. The electronic device of claim 1,
wherein the first image comprises the first object and a portion of a second object positioned behind the first object, and
wherein the second image comprises the first object and an entire region of the second object.

4. The electronic device of claim 3, wherein the one or more computer programs further include computer-executable instructions, that, when executed by the one or more processors individually or collectively, cause the electronic device to determine the second zoom magnification, based on a boundary line of the second object included in the second image.

5. The electronic device of claim 4, wherein the one or more computer programs further include computer-executable instructions, that, when executed by the one or more processors individually or collectively, cause the electronic device to determine the second zoom magnification as a zoom magnification at which the entire region of the second object included in the second image is displayable.

6. The electronic device of claim 5, wherein the one or more computer programs further include computer-executable instructions, that, when executed by the one or more processors individually or collectively, cause the electronic device to determine the second zoom magnification of the second image by a binary search using the first zoom magnification and an optical zoom magnification of the first camera.

7. The electronic device of one of claim 1, wherein the one or more computer programs further include computer-executable instructions, that, when executed by the one or more processors individually or collectively, cause the electronic device to store the composite image in response to the zoom magnification of the second image changing from the first zoom magnification to the second zoom magnification.

8. The electronic device of one of claim 1, wherein the one or more computer programs further include computer-executable instructions, that, when executed by the one or more processors individually or collectively, cause the electronic device to:
provide, via the display, a zoom configuration user interface (UI) for configuring a zoom magnification at least partially concurrently with displaying the second preview image; and
change the zoom magnification of the second image to the second zoom magnification, while maintaining a size of the first object image, based on a third user input on the zoom configuration UI.

9. The electronic device of one of claim 1, wherein the one or more computer programs further include computer-executable instructions, that, when executed by the one or more processors individually or collectively, cause the electronic device to store the composite image, based on a fourth user input which is input while the third preview image is displayed.

10. The electronic device of one of claim 1, wherein the one or more computer programs further include computer-executable instructions, that, when executed by the one or more processors individually or collectively, cause the electronic device to:
display a mode configuration UI, configured to guide execution of a dynamic zoom mode, on the display in case that the first image comprises the first object and a partial region of a second object positioned behind the first object; and
in case that the dynamic zoom mode is executed based on a fourth user input on the mode configuration UI, generate the first object image, display the second preview image, and display the third preview image.

11. The electronic device of one of claim 1, wherein the one or more computer programs further include computer-executable instructions, that, when executed by the one or more processors individually or collectively, cause the electronic device to further overlay and display a third object image, generated by extracting a third object from the first image, on the second preview image and the third preview image in case that the first object and the third object are selected from multiple objects included in the first image, based on a fifth user input.

12. An electronic device comprising:
a display;
a first camera;
a second camera having a field of view different from that of the first camera;
memory storing one or more computer programs; and
one or more processors communicatively coupled to the display, the first camera, the second camera and the memory,
wherein the one or more computer programs include computer-executable instructions that, when executed by the one or more processors individually or collectively, cause the electronic device to:
display, on the display, a first preview image comprising a first image that is acquired using the first camera,
generate a first object image associated with a first object among the first object and a second object included in the first preview image,
display, on the display, a second preview image comprising the first object image and a second image acquired using the second camera, the second image comprising the second object,
adjust and display the second image on the second preview image according to a selected magnification, and
store a third image corresponding to the second preview image.

13. The electronic device of claim 12, wherein the second image further comprises the first object, and the first object image included in the second preview image is at least partially overlayed and displayed on the first object included in the second preview image.

14. The electronic device of claim 12, wherein the one or more computer programs further include computer-executable instructions, that, when executed by the one or more processors individually or collectively, cause the electronic device to:
switch to a photographing mode in which the second preview image is provided, based on a determination that only a portion of the second object is displayable on the first preview image; and
display the second preview image in case that a photographing command is received in the switched photographing mode.

15. The electronic device of claim 12, wherein the one or more computer programs further include computer-executable instructions, that, when executed by the one or more processors individually or collectively, cause the electronic device to display, on the display, a user interface (UI) configured to guide movement of a position of the electronic device such that an entirety of the second object is displayable on the second preview image.

16. The electronic device of claim 12, wherein the magnification is automatically selected by the electronic device such that at least an entirety of the second object is displayed in the second preview image.

17. The electronic device of claim 12, wherein the one or more computer programs further include computer-executable instructions, that, when executed by the one or more processors individually or collectively, cause the electronic device to, while the first preview image is displayed, acquire a second object image representing the second object by using the second camera, and generate the third image by using a portion of the second object image.

18. The electronic device of claim 12,
wherein the first preview image and the second preview image comprise a third object, and
wherein in case that an input for specifying that the first object is to be generated as the first object image is received from a user, the third object is removed from the third image by an artificial intelligence model and a position of the third object is in-painted with other image information.

19. A method performed by an electronic device for capturing an image, the method comprising:
displaying, by the electronic device, a first preview image comprising a first image having a first zoom magnification and acquired using a first camera;
generating, by the electronic device, a first object image by extracting a first object included in the first image in response to a first user input while the first preview image is displayed;
displaying, by the electronic device, a second preview image obtained by overlaying the first object image on a second image having the first zoom magnification and acquired using a second camera having a field of view different from that of the first camera;
changing, by the electronic device, the zoom magnification of the second image to a second zoom magnification, and display a third preview image obtained by overlaying the first object image on the second image having the second zoom magnification; and
storing, by the electronic device, a composite image corresponding to the displayed third preview image.

20. One or more non-transitory computer-readable storage media storing one or more computer programs including computer-executable instructions that, when executed by one or more processors of an electronic device individually or collectively, cause the electronic device to perform operations, the operations comprising:
displaying, by the electronic device, a first preview image comprising a first image having a first zoom magnification and acquired using a first camera;
generating, by the electronic device, a first object image by extracting a first object included in the first image in response to a first user input while the first preview image is displayed;
displaying, by the electronic device, a second preview image by overlaying the first object image on a second image having the first zoom magnification and acquired using a second camera having a field of view different from that of the first camera;
changing, by the electronic device, the zoom magnification of the second image to a second zoom magnification, and displaying a third preview image obtained by overlaying the first object image on the second image having the second zoom magnification; and
storing, by the electronic device, a composite image corresponding to the displayed third preview image.
